(19) United States
(12) Patent Application Publication
(10) Pub. No.: US 2014/0067631 A1
(43) Pub. Date: Mar. 6, 2014

(54) Systems and Methods for Processing Structured Data from a Document Image

(71) Applicant: Helix Systems Incorporated, Chicago, IL (US)

(72) Inventors: Greg Dhuse, Chicago, IL (US); Joseph T. VanDeventer, Chicago, IL (US)

(73) Assignee: Helix Systems Incorporated, Chicago, IL (US)

(21) Appl. No.: 14/019,510

(22) Filed: Sep. 5, 2013

Related U.S. Application Data
(60) Provisional application No. 61/697,271, filed on Sep. 5, 2012.

(51) Int. Cl. G06Q 40/00

(52) U.S. Cl. CPC G06Q 40/10
USPC 705/30

(57) ABSTRACT

Optical character recognition systems and methods including the steps of: capturing an image of a document including a set of numbers having a defined mathematical relationship; analyzing the image to determine line segments; analyzing each line segment to determine one or more character segments; analyzing each character segment to determine possible interpretations, each interpretation having an associated predicted probability of being accurate; forming a weighted finite state transducer for each interpretation, wherein the weights are based on the predicted probabilities; combining the weighted finite state transducer for each interpretation into a document model weighted finite state transducer that encodes the defined mathematical relationship; searching the document model weighted finite state transducer for the lowest weight path, which is an interpretation of the document that is most likely to accurately represent the document; and outputting an optical character recognition version of the captured image.

### BACKGROUND OF THE INVENTION

The present subject matter relates generally to systems and methods for processing structured information from an image of a document. More specifically, the present invention relates to an optical character recognition system in which an image of a document is captured, wherein the document includes a set of numbers having a predefined mathematical relationship, various optical character recognition (“OCR”) document models are created based on the image, and one of the models is selected as a document model satisfying the defined mathematical relationship and having the highest predicted likelihood of being accurate. Various implementations are contemplated, including a check-splitting mobile application in which a user captures an image of a receipt, the data elements of the receipt are identified and modeled in a representative form, and the user may then manipulate the data elements to assign a subtotal owed by each of a group of users.

Computers have enabled numerous advancements in billing, payment processing, accounting, and bookkeeping by automating complex, tedious, or error-prone numerical tasks. However, many numerical tasks lack computer-based solutions. For example, one common problem experienced by people dining together at a restaurant is the annoyance and awkwardness associated with splitting the bill at the end of a meal. The physical nature of the receipt and the need to quickly pay the bill has prevented computer-based solutions to the bill splitting from reaching market adoption.

There is a need to make structured numerical data in physical documents available for processing by importing the data into a computer in an accurate, structured form. Previous solutions, such as manual data entry, are time consuming, expensive, and vulnerable to human error. An automated solution would be preferred.

Optical character recognition (OCR) technology attempts to automate the procedure of data import by using a computer to analyze images of printed or handwritten documents in order to build an accurate digital representation that is suitable for processing. However, previous OCR approaches are vulnerable to errors caused by inaccuracies in document recognition or defects in the document image, therefore reducing the quality of the imported data and potentially introducing inaccuracies in the final output. Thus, there is a need for OCR technologies that overcome the problems associated with previous OCR techniques.

Further, widespread availability of mobile computing devices introduces the potential for new applications that process structured textual data. Possible applications include mobile payment processing, inventory management, and expense tracking. One problem common to all such applications is the need to develop natural and functional interfaces for importing and manipulating structured textual data on mobile devices. The ability to accurately import structured numerical data into computing devices is critical to these processes.

Accordingly, there is a need for systems and methods for processing structured information from an image of a document, as described herein.

### BRIEF SUMMARY OF THE INVENTION

To meet the needs described above and others, the present disclosure provides an optical character recognition system in which an image of a document is captured, wherein the document includes a set of numbers having a predefined mathematical relationship, various optical character recognition (“OCR”) document models are created based on the image, and one of the models is selected as a document model satisfying the defined mathematical relationship and having the highest predicted likelihood of being accurate. The subject matter taught herein introduces novel systems and methods for importing structured numerical data that reduces errors and improves the accuracy of OCR, even when analyzing low-quality document images.

Various implementations are contemplated, including a check-splitting mobile application in which a user captures an image of a receipt, the data elements of the receipt are identified and modeled in a representative form, and the user may then manipulate the data elements to assign a subtotal owed by each of a group of users.

OCR is the process of importing textual information from a document into a computer by analyzing an image of the document in order to identify the corresponding text. The OCR process typically consists of multiple steps in which the document image is analyzed and transformed into a series of intermediate representations by the computer before the final textual representation is determined. The accuracy of the imported text relative to the source document is important because errors in OCR negatively affect later computation and analysis performed using the imported data.

The following is a description of the OCR process taught herein. Some of the examples provided will relate specifically to a check splitting mobile application embodiment, but it is understood that this embodiment is only one of many embodiments that may incorporate the unique systems and methods taught herein.

In the OCR process taught herein, text is extracted from a document image through a binarization process. Binarization attempts to separate pixels belonging to the foreground of the image, usually text or other features of interest, from the background using variations in pixel intensity or color. Binarization converts a color or grayscale image into a two-tone binary image where foreground pixels are represented in black and background pixels are represented in white. Numerous methods for binarization are well known in the art. It is understood that the class of adaptive, or local, algorithms are preferred for the OCR process taught herein. One technique for local binarization is Sauvola's algorithm, which determines the threshold for each pixel based on the mean and standard deviation of pixels in the neighborhood around that pixel. The disclosed system improves on Sauvola's algorithm by analyzing the image to determine its sharpness or contrast and then computing the Sauvola input parameter. The system then pre-processes the image by applying a Gaussian blur based on the computed value.

The next step in the process is to determine the region of interest (ROI) of the binarized image by including pixels that correspond to text and excluding pixels that correspond to noise or other non-text features. For example, the ROI may be represented as a rectangular region of the image including every pixel representing text and excluding as many non-text pixels as possible. In such an example, the system may project the image onto its horizontal (x) and vertical (y) axes and compute the ROI by analyzing the projections, looking for features that indicate borders of noise around the text. Once the ROI has been calculated, the binarized image is refined by setting all foreground (black) pixels that lie outside the ROI to white, indicating that they are no longer of interest to the OCR system.

In the next step, foreground pixels are grouped into lines based on their location in the image. A line represents a word, sentence, or other text that is close together in the same horizontal strip of pixels, much like a line of text in a book. For example, when interpreting the text and prices on a receipt, a line may correspond to a price, an item description, extraneous text such as an address, or some combination of these data elements. The disclosed method groups foreground pixels within the ROI into lines by smearing them horizontally in the digital image (similar to smearing wet ink on a page) and grouping pixels together into the same line if they are connected in the smeared representation.

Next, each line is segmented horizontally into small vertical strips of foreground pixels that represent a single letter, number, other character, or some part of one of these. Document images taken using low-quality mobile cameras under non-ideal lighting conditions, or representing documents with damage or other physical defects, often include noise pixels that may be erroneously determined to be part of the foreground and included in a line. Similarly, poor focus or lighting may cause adjacent characters within a line to appear connected in the binarized image. The disclosed method for character segmentation over-segments lines into characters by conservatively splitting the line into strips of pixels at boundaries that correspond to a valley in the line's projection onto the horizontal (x) axis. Since a character segment may represent part or all of a character in the text, multiple segments must be grouped together into logical characters during text recognition.

In the next step, a character classifier analyzes each line to recognize groups of character segments as numbers, letters, or other symbols. In one embodiment, the character classifier is a Multi-Layer Perceptron (MLP) neural network trained on sample text. Since a character segment may represent all or only part of a character, segments are grouped together with zero or more of their neighbors during classification. A single character segment may be part of many groupings. For example, a character segment “a” with two adjacent segments “b” and “c” can be grouped: “a,” “ab,” and “abc.” Each group is analyzed by the character classifier, which takes as input the pixels corresponding to a character segment group and outputs zero or more possible character classifications. For example, the grouping of character segments “ab” may be classified a 10% probability of representing the number “0,” a 40% probability of representing the letter “D,” and a 50% probability of representing the number “8.” A Weighted Finite State Transducer (wFST) is assembled from all possible interpretations of each line, and the probability of each interpretation is used to determine a corresponding path weight in the wFST.

When the document includes structured numerical data, a model is constructed that represents this structure in order to increase accuracy of the imported results. The disclosed process builds a model by identifying lines in the document that have a high probability of representing structured numerical data, and then constructs a new composite wFST out of the individual wFSTs associated with those lines. The composite wFST represents all possible interpretations for the document's structured numerical data and only accepts solutions that satisfy the model conditions. For example, the structured numerical data may be based on a given mathematical relationship. The mathematical relationship may be, for example, that one set of numbers in the document may be added to equal another number in the document. Accordingly, only composite wFST models that satisfy this relationship will be accepted.

The process of identifying lines that are likely to represent structured numerical data in a document includes analyzing the layout of lines in the document based on known document structures. For example, most printed restaurant receipts have two columns containing item descriptions and their corresponding prices, as well as some extraneous header and footer text. Layout information for each type of document is encoded as a collection of probabilities. Restaurants in the United States, for example, print receipts with prices in the right-hand column with higher probability than the left-hand column. Similarly, the total of a receipt is often, but not always, in the same column as food and drink items. Similarly, the likelihood of any individual line corresponding to structured numerical data is estimated based on its individual wFST. In the example of a receipt, lines that can be interpreted as containing one or more valid prices have a high likelihood of being included in the model.

The composite wFST represents all possible interpretations for the document's structured numerical data as a combination of interpretations of each included line. Only solutions that satisfy the model conditions are accepted by the composite wFST, which eliminates any potential solutions that are known to contain OCR errors from the final document interpretation. For example, valid solutions of a restaurant receipt must have the property that all food items, tax, and tip minus discounts sum to the total. In this example, the composite wFST is built by composing the individual wFSTs from each included line, specific glue wFSTs, and an adder wFST that only accepts solutions where the individual line interpretations, taken together, satisfy this condition.

The final step of the OCR process is searching the composite wFST for the highest quality solution, which represents the interpretation of the document's structured numerical data with the lowest probability of containing recognition errors. In a preferred example, this is done with an efficient A-star (A*) search on the composite wFST using a heuristic based on the weights encoded in the wFST. The path of lowest weight that is accepted by the composite wFST is the highest quality solution, and the disclosed method converts this solution to an interpretation of the original document that can be used by the computer for computation and analysis.

In some instances, additional information is available that can help correct errors in the OCR process or reduce the time to find a solution. In the disclosed system, any individual line wFST can be manually replaced with a wFST corresponding to a known interpretation of that line. For example, in a restaurant receipt, the user may identify a particular line as the total and enter its actual value. After receiving the user input, the replacement wFST has only one potential interpretation, the actual value, and is weighted such that this interpretation is used in all valid document solutions.

The disclosure provided herein enables mobile devices equipped with cameras and touch-sensitive screens to utilize specialized interfaces for efficient manipulation of data. For example, structured textual data may be imported into a mobile device using an OCR process and presented to the user as an on-screen representation of the original document image. The representation is backed by: (1) a computer-generated physical model; and (2) the imported document data in a computer-usable format. The physical model allows the user to manipulate text and numbers in the document by touching, tapping, and dragging the on-screen representation in a natural way that is not possible with a paper document. As the user manipulates lines in the document image, the corresponding computer-usable representation is manipulated off-screen. In one embodiment, a restaurant receipt is imported and a physical model of it is constructed. The user can then physically touch and drag each item on the receipt into a list or other grouping, and the computer calculates the total price of all items in the list from the computer-usable representation of each item. In another embodiment, a document containing text is imported. The user can then edit the document by touching and dragging words and sentences on the screen, which results in the corresponding edits to the computer-usable representation. When finished, the user can print the updated version of the document shown on-screen, or send the computer-usable representation via email.

Various embodiments may be formed using the OCR and physical manipulation of structured data processes described above. One such embodiment is a check-splitting mobile application. A check-splitting mobile application embodiment is described below.

As described herein, the problem of splitting restaurant checks amongst a group of diners can be solved using a combination of the advanced OCR and physical manipulation of the imported structured textual information processes provided in the present disclosure.

The first step is acquiring an image with which to perform the OCR process. This is done using the camera on a mobile device, using image analysis, and built-in sensors to help the user take a higher quality picture for increased OCR accuracy. The device's gyroscope, if present, may be used to ensure the camera is being held level, and the incoming image may be analyzed for lighting information to determine whether or not the flash should be enabled. This information may be relayed to the user via on-screen cues. For example, a pair of level indicators may appear on the right and left sides of the screen, changing color to indicate to the user whether the device is being held parallel to the document image, as well as to indicate the acceptable tilt range. A prompt may give the user warnings about lighting and device orientation, and the user may further be prompted to illuminate the device's torchlight to improve document lighting.

The next step is to classify the image using OCR. While the document image is processed, the user can decrease recognition time and increase accuracy by tapping a given price and entering the amount and type of price (food and drink, tax, tip, etc.). Input from the device's sensors may be used to increase the likelihood of finding a specific item classification. For instance, the GPS sensor may be used to determine the local sales tax rate.

In one example, when manually entering an amount, the device presents the user with a heavily magnified image of the area believed to represent one specific price line. The user can enter the price via onscreen keyboard (or by selecting amongst prepopulated alternatives) and select the price type from a list. When the user is finished, the receipt model is updated to include this extra information and the OCR process is restarted.

Once the device has constructed a model of the receipt (for example, as described above), it presents the results to the user for approval. From here, the user can manually correct any mistakes using the screen detailed above, or accept the result and move on to the assignment screen.

In the example provided herein, the assignment screen contains two areas: a list of all guests who will be splitting the check; and a specially formatted image of the receipt itself.

In one example, an icon is displayed to represent each guest and running total is provided underneath each icon. Tapping a guest's icon toggles to highlight the receipt items currently assigned to the guest. By tapping an “edit” button, guests can be added to or removed from the list, or individual guest icons can be edited. An icon for a person can be obtained from a variety of sources. In one embodiment, an icon can be chosen from a list of pre-made icons to represent each guest. To differentiate between two guests with the same icon, a customizable color can be selected to appear in the background or border. In another embodiment, the user browses the device's contact list or photo album and selects a pre-existing photo for each guest. In yet another embodiment, the device's camera is used to take a quick portrait of diners around the table. A preview of the photo is shown, and a new guest may be added using the current previewed image as the icon.

Another area of the assignment screen displays the receipt. A collapsed view of the receipt scales receipt items to maximize the area of the screen occupied by price and receipt item descriptions by eliminating whitespace between items to save screen space, maximize touch area, and eliminate clutter. A zoom button may be used to toggle between the collapsed view and a full view of the entire receipt.

To assign a purchased item to a guest, the user drags the price on the receipt onto the icon representing the person who ordered that item. An animation indicates visually that the item has been assigned to a particular guest, and the item is then marked on the receipt to indicate that has been assigned (for example, the item may be highlighted or colored to indicate its assignment). The guest's running total is updated to reflect the item's price.

A second group of buttons may appear during the item assignment process. These buttons represent special modes of assignment such as sales tax or tip, plus the ability to split an item between all or some guests.

Splitting an item between guests triggers a dialog that allows the user to choose which guests split the item by indicating how many shares of the item each guest should pay for. For example, if Guest A orders two drinks and Guest B orders one of the same kind of drink, they might be represented as a single line on the receipt for the total of all three drinks By choosing to split this item, the user taps Guest A twice and Guest B once to split the item into thirds accordingly.

The bottom of the assignment screen indicates how many items remain to be assigned. Once every item has been assigned, the user can accept the assignments and continue to the payment screen.

The payment screen displays each person's icon next to his or her relevant payment data; the total before tax, share of tax, share of tip, and total amount to pay. Initially, each guest is assumed to pay individually, however multiple guests can be indicated to pay together by dragging guest icons into the same area of the screen. In another embodiment, guests may automatically be grouped using information from the device's contact list. For example, married couples may automatically be assumed to pay together as a group.

A payment button allows people to pay the user their individual share at the table using an online payment service, such as PayPal. In one embodiment, multiple devices communicate to learn each guest group's total and each group pays separately using their own device. In another embodiment, the restaurant provides an electronic payment service and each guest pays their determined amount directly using their own device.

The bottom of the screen shows the grand total, plus options to adjust tip percentage (which is automatically calculated if the tip was included on the receipt and marked as such on the calculation screen), whether or not the tip includes sales tax, and whether or not to round each person's total to the nearest dollar amount. In another embodiment, each guest group's total is rounded either up or down to the nearest dollar amount such that the total amount paid by all groups is as close as possible to the bill's overall total without going under.

The summary of the check-splitting application is just one embodiment of the teaching provided herein. Those skilled in the art will recognize how the disclosed subject matter may be used to provide other systems and methods for mobile payment processing, inventory management, expense tracking, balancing a checkbook, verifying a correct Sudoku solution, etc.

In one example, an optical character recognition system includes: a processor; a memory in communication with the processor, including stored instructions that, when executed by the processor, cause it to perform the steps of: capturing an image of a document; generating a model based on optical recognition of text data derived from the image, wherein the model includes: a plurality of item elements, each item element including an item description and an item price; and a total price or subtotal price, wherein the summation of the prices of the item elements equal the total price or subtotal price; and providing a user interface to permit a user to assign one or more item elements to one of a plurality of groups wherein the assigned item elements are used to calculate an assigned cost for each of the groups.

The step of generating a model based on optical recognition of text data derived from the image may include the steps of: analyzing the image to determine a plurality of line segments; analyzing each line segment to determine one or more character segments; analyzing each character segment to determine a plurality of possible interpretations, each interpretation having an associated predicted probability of being an accurate representation of the character in the document; and forming one or more document models based on combinations of the possible interpretations of the character segments.

The character segment interpretations and document models may be represented by weighted finite state transducers.

The memory may further include stored instructions that when executed by the processor cause it to perform the step of: providing a user interface through which a user verifies the accuracy of one of an item price, a subtotal price, or a total price.

The user verification may eliminate one or more models from being selected as the document model having the highest predicted likelihood of the summation of the price associated with each of the item elements equaling the total or subtotal.

The user interface may permit a user to assign one or more item elements to one of a plurality of groups includes a graphical representation of the item elements and a graphical representation of the plurality of groups wherein the user may manipulate graphical representation of an item element to assign the item element to the group.

The user may manipulate the graphical representation of an item element to assign the item element to the group through a touch screen based interface.

The plurality of item elements may represent items collectively purchased by individuals and each group of the plurality of groups includes one or more of the individuals.

The memory may further include stored instructions that when executed by the processor cause it to perform the step of: initiating an electronic payment API request to send or receive payment for at least one of the one or more guests.

The step of providing a user interface to permit a user to assign one or more item elements to one of a plurality of groups may include displaying a zoomed-in image of the document generated by the steps of: identifying foreground pixels and background pixels in the image of the document; extracting the foreground pixels; filling in the foreground pixels using background estimation to form a background image of the document; modifying the foreground pixels to eliminate whitespace; and rendering the foreground pixels onto the background image of the document to generate a modified electronic version of the document with reduced whitespace.

The step of displaying a zoomed-in image of the document may include the step of: rendering sharper text over the foreground pixels by replacing the foreground pixels with the item descriptions and item prices from the model having the highest predicted likelihood of the summation of the price associated with each of the item elements equaling the total or subtotal.

In another example, an optical character recognition system includes: a processor; a memory in communication with the processor, including stored instructions that, when executed by the processor, cause it to perform the steps of: capturing an image of a document, wherein the captured image includes a set of numbers having a defined mathematical relationship; generating a plurality of document models each including a unique set of numbers based on a unique interpretation of the captured image; searching the plurality of document models to select a document model satisfying the defined mathematical relationship and having the highest predicted probability of being an accurate representation of the document; and outputting the optical character recognition version of the captured image based on the selected model.

The step of generating a plurality of document models each including a unique set of numbers based on a unique interpretation of the captured image may include the steps of: identifying a plurality of line segments in the captured image; identifying one or more character segments in each line segment; generating a plurality of line segment models by assigning one or more values to each character segment in each line segment, wherein each assigned value includes an associated predicted likelihood of being an accurate representation of the character in the document; and generating a plurality of document models from combinations of line segment models.

The line segment models and document models may be represented by weighted finite state transducers.

The memory may further include stored instructions that, when executed by the processor, cause it to perform the step of: providing a user interface through which a user verifies the accuracy of one of the line segment models.

The document may be a receipt including a plurality of item elements, each item element including an item description and an item price, and a total price or subtotal price, wherein the defined mathematical relationship is that the summation of the prices of the item elements equal the total price or subtotal price.

The memory may further include stored instructions that when executed by the processor cause it to perform the step of: providing a user interface to permit a user to assign one or more item elements to one of a plurality of groups wherein the assigned item elements are used to calculate an assigned cost for each of the groups.

The step of providing a user interface to permit a user to assign one or more item elements to one of a plurality of groups may include displaying a zoomed-in image of the document generated by the steps of: identifying foreground pixels and background pixels in the image of the document; extracting the foreground pixels; filling in the foreground pixels using background estimation to form a background image of the document; modifying the foreground pixels to eliminate whitespace; and rendering the foreground pixels onto the background image of the document to generate a modified electronic version of the document with reduced whitespace.

The user interface may permit a user to assign one or more item elements to one of a plurality of groups includes a graphical representation of the item elements and a graphical representation of the plurality of groups wherein the user may manipulate graphical representation of an item element to assign the item element to the group.

In yet another example, an optical character recognition system includes: a processor; a memory in communication with the processor, including stored instructions that, when executed by the processor, cause it to perform the steps of: capturing an image of a document, wherein the captured image includes a set of numbers having a defined mathematical relationship; analyzing the image to determine a plurality of line segments; analyzing each line segment to determine one or more character segments; analyzing each character segment to determine a plurality of possible interpretations, each interpretation having an associated predicted likelihood of being an accurate representation of the character in the document; forming a weighted finite state transducer for each interpretation, wherein the weights are based on the predicted probabilities; combining the weighted finite state transducer for each interpretation into a document model weighted finite state transducer that encodes the defined mathematical relationship; searching the document model weighted finite state transducer for the lowest weight path, which is an interpretation of the document that is most likely to accurately represent the document; and outputting an optical character recognition version of the captured image based on the lowest weight path of the document model weighted finite state transducer.

An object of the invention is to make structured numerical data in physical documents available for processing by importing the data into a computer in an accurate, structured form.

Another object of the invention is to make structured numerical data easy to manipulate on a computer.

A further object is to eliminate the annoyance and awkwardness associated with splitting the bill at the end of a meal.

An advantage of the invention is that it improves the optical character recognition of structured textual data by incorporating implicit information about the structure of the data.

Another advantage of the invention is that enables new applications for manipulation of structured textual data on computing devices, including mobile devices with a camera and touchscreen.

A further advantage of the invention is that provides for user feedback to quickly correct errors in optical character recognition.

Yet another advantage of the invention is that it permits the viewing of document images on small computer form factors by eliminating white space.

Another advantage of the invention is that it provides a mechanism to split a bill without requiring complicated data entry or manipulation.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram of a mobile device that may embody the systems and methods described herein.

FIG. 2 is a flow chart of a process of implementing an optical character recognition system.

FIG. 3 is a flow chart of a process of implementing a check-splitting mobile application.

FIG. 4 is an example of a document image captured by the mobile device of FIG. 1.

FIG. 5 is the document image of FIG. 4 processed to show the regions of pixels connected by smearing.

FIG. 6 is the document image of FIG. 4 processed to show discovered line segments.

FIG. 7 illustrates an example of splitting a line segment into one or more character segments.

FIG. 8a illustrates an example of a weighted finite state transducer (wFST) representing the line segment of FIG. 7.

FIG. 8b illustrates an example of a path of the wFST of FIG. 8a.

FIG. 9 is an example of a line filter wFST that accepts numbers formatted as prices.

FIG. 10 is an example of a filtered line wFST formed from the composition of the wFSTs of FIGS. 8a and 9.

FIG. 11 is an example of column finding in a document image of a receipt.

FIG. 12 is an excerpt of an example restaurant receipt with item prices, a sub-total, tax fields, and a total.

FIG. 13 illustrates the construction by composition of an example document model wFST.

FIG. 14 illustrates a simplified document model wFST and the expansion of the filtered line wFST corresponding to one of its component lines.

FIG. 15 illustrates the document model wFST of FIG. 14 where a filtered line wFST is to be replaced with user input representing a correction.

FIG. 16 illustrates an example of a document image.

FIG. 17 illustrates the document image of FIG. 16 with selected text removed.

FIG. 18 shows an example original document image.

FIG. 19 illustrates the document from FIG. 18 using a layout that retains text while eliminating extra whitespace between the columns.

FIG. 20 shows a screenshot of an example user interface displaying a classification screen.

FIG. 21 illustrates an example of an assignment screen for use in splitting a check.

FIG. 22 illustrates an example of a screenshot during a user action of dragging a price line.

FIG. 23 illustrates an example of a payment screen showing total, tax, and tip information for each party.

FIG. 24 illustrates a Tip & Rounding screen to adjust certain aspects of payment calculation.

### DETAILED DESCRIPTION OF THE INVENTION

The present disclosure provides an optical character recognition system in which an image of a document is captured, wherein the document includes a set of numbers having a predefined mathematical relationship, various optical character recognition (“OCR”) document models are created based on the image, and one of the document models is selected as being the document model satisfying the defined mathematical relationship and having the highest predicted likelihood of being accurate. The subject matter taught herein introduces systems and methods for importing structured numerical data that reduces errors and improves the accuracy of OCR, even when analyzing low-quality document images.

Various implementations are contemplated, including a check-splitting mobile application in which a user captures an image of a receipt, the data elements of the receipt are identified and modeled in a representative form, and the user may then manipulate the data elements to assign a subtotal owed by each of a group of users. Many of the examples provided in the detailed description relate to the check-splitting mobile application embodiment. However, this embodiment was chosen for its clarity for presenting and explaining the underlying technology and the application of the underlying technology into varied contexts and embodiments will be understood by those skilled in the art based on the disclosures provided herein.

Many, but not all, of the contemplated embodiments of the presently disclosed subject matter can be implemented using a mobile device 100, such as a smartphone. Though used as the primary embodiment described herein, a mobile device 100 is only one example of a hardware system that may be used to accomplish the solutions provided by the present disclosure. Any computing system with the relevant peripherals may be utilized to accomplish the solutions, as will be recognized by those skilled in the art.

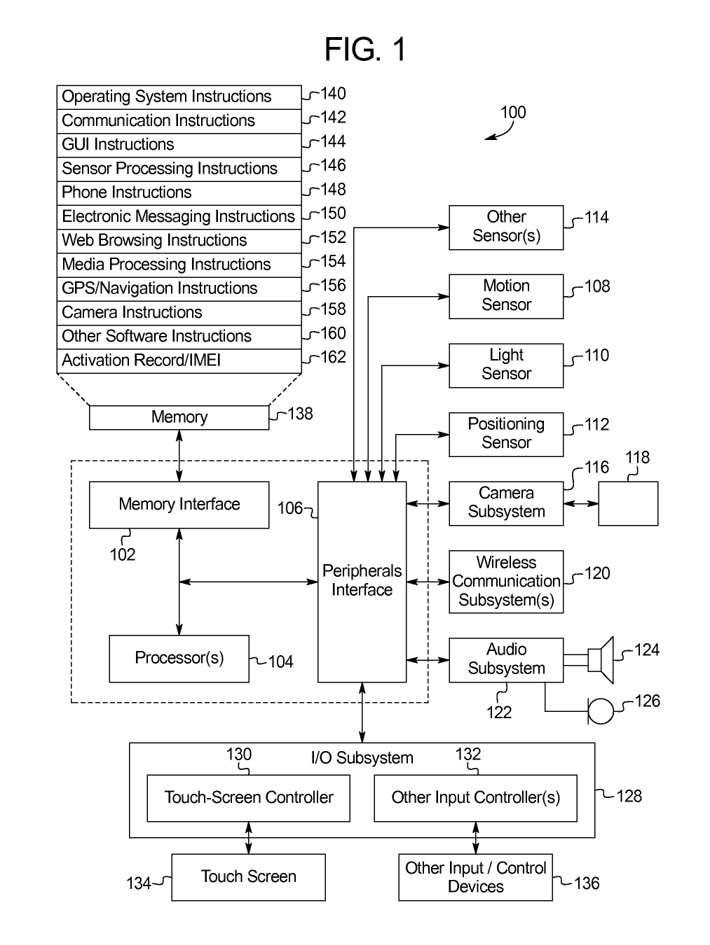

FIG. 1 is a block diagram of an example implementation of a mobile device 100. Referring to FIG. 1, the mobile device 100 includes a memory interface 102, one or more data processors, image processors and/or central processors 104, and a peripherals interface 106. The memory interface 102, the one or more processors 104 and/or the peripherals interface 106 can be separate components or can be integrated in one or more integrated circuits. The various components in the mobile device 100 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 110, and a positioning sensor 112 (e.g., GPS receiver) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through one or more wireless communication subsystems 120, which can include radio frequency receivers and transmitters and/or optical (e.g., infrared) receivers and transmitters. The specific design and implementation of the communication subsystem 120 can depend on the communication network(s) over which the mobile device 100 is intended to operate. For example, the mobile device 100 can include communication subsystems 120 designed to operate over a GSM network, a GPRS network, an EDGE network, a Wi-Fi or WiMax network, and a Bluetooth™ network. In particular, the wireless communication subsystems 120 may include hosting protocols such that the mobile device 100 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 can include a touch screen controller 130 and/or other input controller(s) 132. The touch-screen controller 130 can be coupled to a touch screen 134. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 can be coupled to memory 138. The memory 138 can include high-speed random access memory and/or non-volatile memory, such as one or more magnetic disk storage devices, one or more optical storage devices, and/or flash memory (e.g., NAND, NOR). The memory 138 can store operating system instructions 140, such as Darwin, RTXC, LINUX, UNIX, OS X, iOS, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 138 may also store communication instructions 142 to facilitate communicating with one or more additional devices, one or more computers and/or one or more servers. The memory 138 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 138 may also store other software instructions (not shown) controlling other processes and functions of the mobile device 100 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 138.

Each of the above identified instructions and applications can correspond to a set of instructions for performing one or more functions described herein. These instructions need not be implemented as separate software programs, procedures, or modules. The memory 138 can include additional instructions or fewer instructions. Furthermore, various functions of the mobile device 100 may be implemented in hardware and/or in software, including in one or more signal processing and/or application specific integrated circuits.

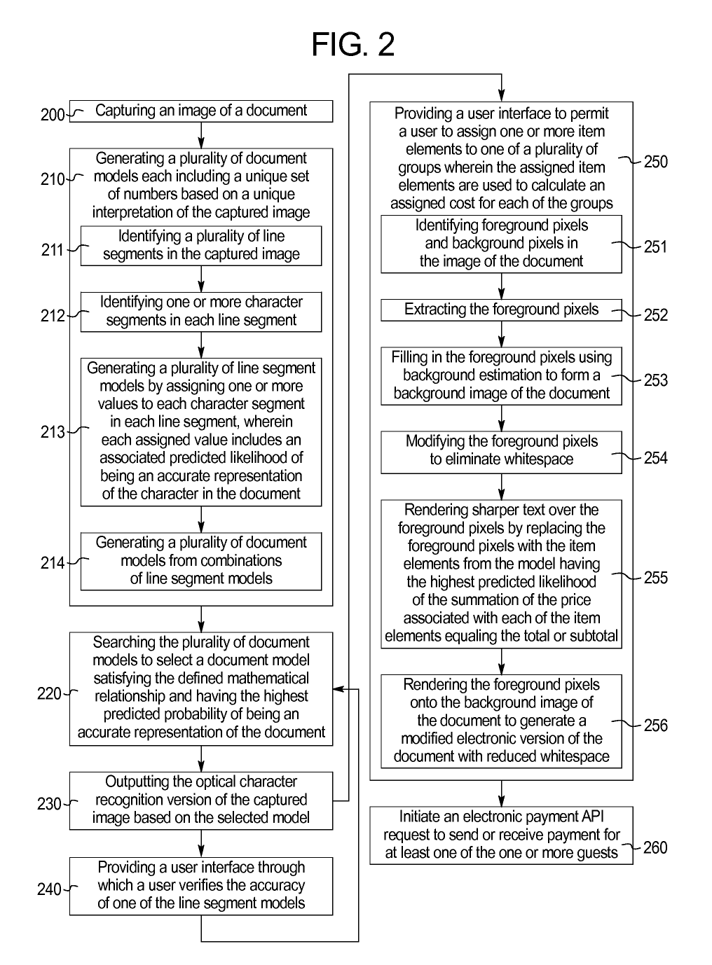

In one example, the memory 138 includes stored instructions that, when executed by the processor 104, cause it to perform optical character recognition by following the steps shown in FIG. 2. As shown in FIG. 2, performing optical character recognition may include the steps of: the step 200 of capturing an image of a document, wherein the captured image includes a set of numbers having a defined mathematical relationship; the step 210 of generating a plurality of document models each including a unique set of numbers based on a unique interpretation of the captured image; the step 220 of searching the plurality of document models to select a document model satisfying the defined mathematical relationship and having the highest predicted probability of being an accurate representation of the document; and the step 230 of outputting the optical character recognition version of the captured image based on the selected model.

As shown in FIG. 2, the step 210 of generating a plurality of document models each including a unique set of numbers based on a unique interpretation of the captured image may include the sub-steps of: sub-step 211 of identifying a plurality of line segments in the captured image; sub-step 212 of identifying one or more character segments in each line segment; sub-step 213 of generating a plurality of line segment models by assigning one or more values to each character segment in each line segment, wherein each assigned value includes an associated predicted likelihood of being an accurate representation of the character in the document; and sub-step 214 of generating a plurality of document models from combinations of line segment models.

As additionally shown in FIG. 2, the memory 138 may further include stored instructions that when executed by the processor 104 cause it to perform the step 250 of: providing a user interface to permit a user to assign one or more item elements to one of a plurality of groups wherein the assigned item elements are used to calculate an assigned cost for each of the groups. The step 250 of providing a user interface to permit a user to assign one or more item elements to one of a plurality of groups may include displaying a zoomed-in image of the document generated by the sub-steps of: sub-step 251 of identifying foreground pixels and background pixels in the image of the document; sub-step 252 of extracting the foreground pixels; sub-step 253 of filling in the foreground pixels using background estimation to form a background image of the document; sub-step 254 of modifying the foreground pixels to eliminate whitespace; and sub-step 255 of rendering the foreground pixels onto the background image of the document to generate a modified electronic version of the document with reduced whitespace. In some embodiments, displaying a zoomed-in image of the document may further include the sub-step 255 of: rendering sharper text over the foreground pixels by replacing the foreground pixels with the item descriptions and item prices from the model having the highest predicted likelihood of the summation of the price associated with each of the item elements equaling the total or subtotal.

As also shown in FIG. 2, the memory 138 may further include stored instructions that when executed by the processor 104 cause it to perform the step 240 of: providing a user interface through which a user verifies the accuracy of one of the line segment models. After step 240, execution may return to step 220 to re-search the plurality of document models to select a document model as being the document model satisfying the defined mathematical relationship and having the highest predicted likelihood of being accurate.

As further shown in FIG. 2, the memory 138 may further includes stored instructions that when executed by the processor 104 cause it to perform the step 260 of: initiating an electronic payment API request to send or receive payment for at least one of the one or more guests.

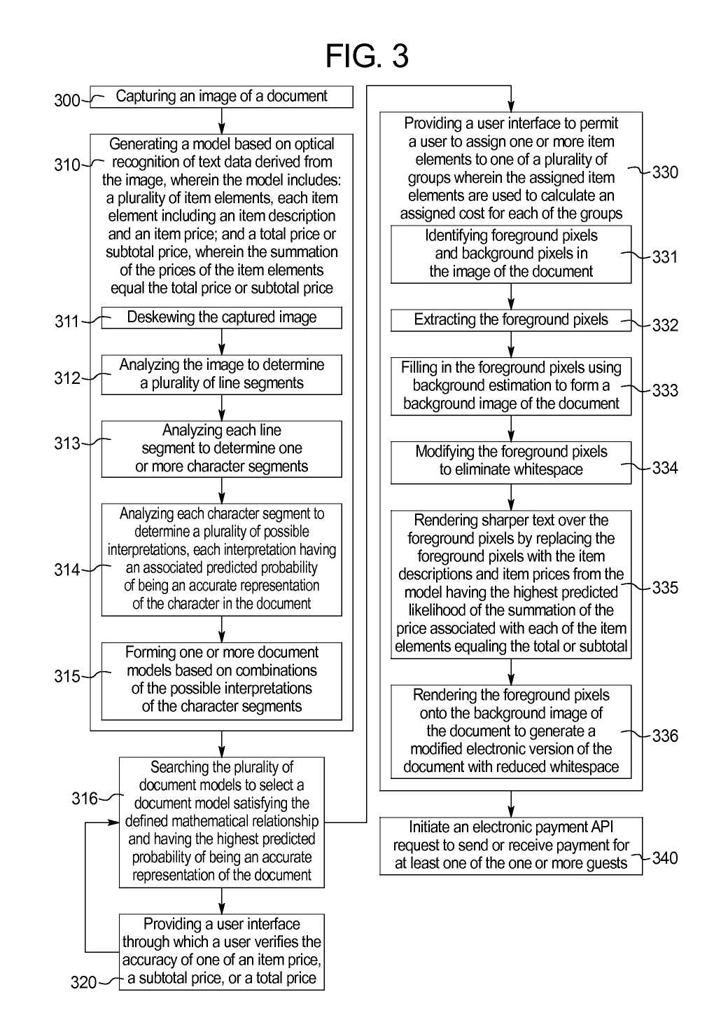

In another example, the memory 138 includes stored instructions that, when executed by the processor 104, cause it to perform the steps shown in FIG. 3 of: step 300 of capturing an image of a document; step 310 of generating a model based on optical recognition of text data derived from the image, wherein the model includes: a plurality of item elements, each item element including an item description and an item price; and a total price or subtotal price, wherein the summation of the prices of the item elements equal the total price or subtotal price; and step 330 of providing a user interface to permit a user to assign one or more item elements to one of a plurality of groups wherein the assigned item elements are used to calculate an assigned cost for each of the groups.

As additionally shown in FIG. 3, the step 310 of generating a model based on optical recognition of text data derived from the image may include the sub-steps of: sub-step 312 of analyzing the image to determine a plurality of line segments; sub-step 313 of analyzing each line segment to determine one or more character segments; sub-step 314 of analyzing each character segment to determine a plurality of possible interpretations, each interpretation having an associated predicted probability of being an accurate representation of the character in the document; sub-step 315 of forming one or more document models based on combinations of the possible interpretations of the character segments; and sub-step 316 of searching the plurality of document models to select a document model satisfying the defined mathematical relationship and having the highest predicted probability of being an accurate representation of the document. In some embodiments, the step 310 may include a further sub-step 311 of: deskewing the captured image.

As further shown in FIG. 3, the memory 138 may further include stored instructions that when executed by the processor 104 cause it to perform the step 320 of: providing a user interface through which a user verifies the accuracy of one of an item price, a subtotal price, or a total price. The user verification eliminates one or more models from being selected as the document model having the highest predicted likelihood of the summation of the price associated with each of the item elements equaling the total or subtotal.

As further shown in FIG. 3, the memory 138 may further includes stored instructions that when executed by the processor 104 cause it to perform the step 340 of: initiating an electronic payment API request to send or receive payment for at least one of the one or more guests.

The step 330 of providing a user interface to permit a user to assign one or more item elements to one of a plurality of groups may include displaying a zoomed-in image of the document generated by the sub-steps of: sub-step 331 of identifying foreground pixels and background pixels in the image of the document; sub-step 332 of extracting the foreground pixels; sub-step 333 of filling in the foreground pixels using background estimation to form a background image of the document; sub-step 334 of modifying the foreground pixels to eliminate whitespace; and sub-step 336 of rendering the foreground pixels onto the background image of the document to generate a modified electronic version of the document with reduced whitespace. In some embodiments, displaying a zoomed-in image of the document may further include the sub-step 335 of: rendering sharper text over the foreground pixels by replacing the foreground pixels with the item descriptions and item prices from the model having the highest predicted likelihood of the summation of the price associated with each of the item elements equaling the total or subtotal.

Optical character recognition. The following is a description of the OCR process taught herein. Some of the examples provided will relate specifically to a check splitting mobile application embodiment, but it is understood that this embodiment is only one of many embodiments that may incorporate the unique systems and methods taught herein.

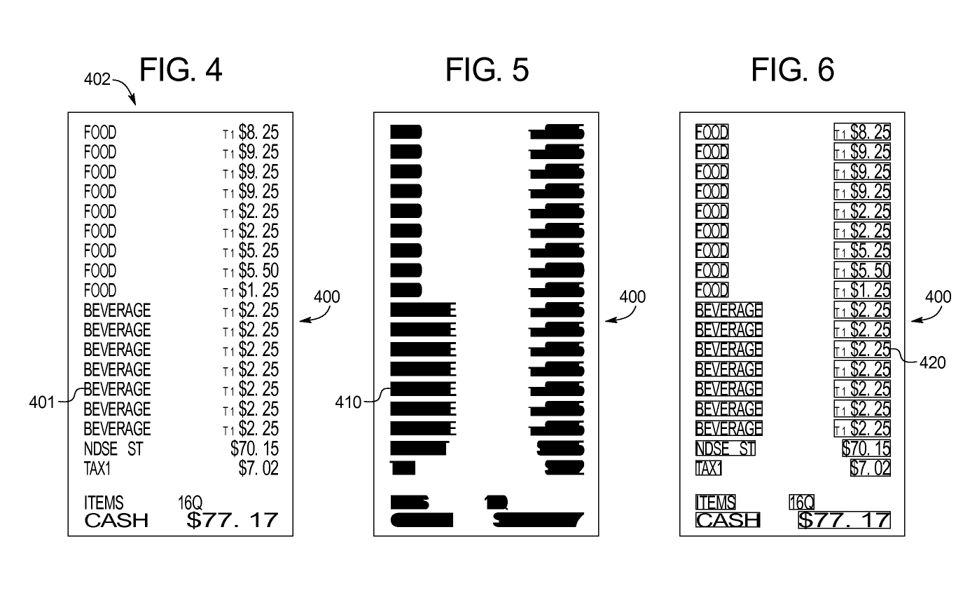

The process of Optical Character Recognition (OCR) begins by capturing a digital document image 400 of the document to be imported. In the example shown in FIG. 4, the document image 400 is a receipt. In one embodiment, the document image 400 is taken using the mobile device 100. In alternate embodiments, the document image 400 may be taken by a hand-held camera or captured by a scanner. After capture, the document image 400 is analyzed and transformed into a series of intermediate representations before resulting in a computer-usable representation of the document's textual data. The disclosed approach is optimized for documents containing structured numerical data. Structured numerical data is defined as text that represents numerical information in a structured format. As an example of structured numerical data, a receipt or invoice contains prices that together sum to the provided total. In another example, an inventory chart represents stock quantity information for each shelf in a warehouse along with the known total quantity of each item.

Reducing document skew. As a first optional step, the document image 400 may be deskewed. The accuracy of OCR depends on the quality of the document image 400 being processed. Images taken at a skew may distort the document's textual information and introduce errors into the resulting text recognition. The document image 400 may be corrected by analyzing the document image 400 to determine its skew, and then applying a rectifying projection to the image such that the deskewed document appears in a fronto-parallel orientation. First, the document image 400 is binarized and then the binarization is inverted. The Radon transform is computed from the inverted binary image, which identifies the position and orientation of strong lines in the document image 400 as bright white regions in the Radon image. Strong horizontal lines in the document image 400 correspond to lines of text in the document, or to the top and bottom edges of the document itself. Strong vertical lines in the document image 400, when present, correspond to the edges of the document page. For example, a digital image 400 of a receipt often includes the left and right edges of the receipt paper, which show up as bright white regions in the Radon image. In one embodiment, the Radon transform may be limited to the top, bottom, left, and right regions in the document image 400 so as to include the edges of a page while excluding the central area of the document.

Bright regions in the radon image are used to compute the document quadrilateral. In one embodiment, the vanishing point of the scene is computed instead of the document quadrilateral for the same purpose. If the document quadrilateral is not a rectangle, the document is skewed with respect to the camera's fronto-parallel plane. The centroid of the document quadrilateral is taken to be the center point of the document image. A projection matrix is calculated such that the document quadrilateral becomes a rectangle in the fronto-parallel plane when multiplied with this matrix, retaining the same centroid as the skewed document quadrilateral. The original document image 400 is then projected using the computed matrix to create the deskewed document image 400.

Binarization. Binarization is the process of separating foreground 401 from background 402 in a document image 400. In a document image 400, the foreground 401 consists of text and the background 402 consists of everything else, often including the document page and extraneous markings and noise. OCR may be performed on the binarized document image, so the quality of binarization has a direct effect on the accuracy of text recognition. Many algorithms for image binarization are known in the art, and can generally be classified as either global or local. Global approaches try to find a single intensity threshold for the entire image. Pixels below (or equivalently, above) this threshold are considered to be in the foreground 401, while pixels above (or equivalently, below) the threshold are considered part of the background 402. Local algorithms compute a threshold for each pixel or neighborhood of pixels and better handle non-uniform lighting conditions and other variations in average intensity across the document, but are generally slower than global methods. The disclosed method improves upon the state-of-the-art by enhancing the Sauvola local binarization algorithm to improve the quality of binarized document images.

First, the document image 400 to be binarized is analyzed and a global measure of sharpness is computed as the average difference in intensity between each pixel and its next neighbor to the right. This value is used to calculate the Sauvola parameter ‘k’ as k=a*(average+1). In one embodiment, the value ‘a’ is taken to be 1.6667*10 ̂−2. Next, the image is processed using a 2-dimensional Gaussian blur with sigma parameter s=min(image_width/1200, 2.0). Finally, the image is further processed by Sauvola's method with the computed parameter ‘k’ to produce the binarized result.

ROI detection. In an embodiment, OCR accuracy and speed may be improved by performing further processing on the binarized document image in order to compute the Region of Interest (ROI) that includes all document text and excludes as many non-text foreground pixels as possible. The disclosed method computes a rectangular ROI by excluding any margins or noise around the top, bottom, left, or right edges of the document image 400 while retaining the portions of the document image 400 that contain text.

First, a copy of the binarized document image may be processed by the morphological erosion operation. Then, projection histograms are computed from the eroded image onto both the vertical (y) and horizontal (x) axes. The y-axis histogram is computed as the number of foreground pixels in each row of the image. The x-axis histogram is computed as the number of background pixels in each column of the document image 400. Both histograms may be smoothed using a 1-dimensional Gaussian blur. In one embodiment, the sigma parameter is taken to be 1.28*10̂−3*image_width+6.68. Next, each histogram is normalized to fall within the range [0, 1). The y-axis histogram is divided into 3 equal regions representing the top, middle, and bottom of the image. A threshold is calculated for the top and bottom regions independently using Otsu's algorithm. If the topmost row of the y-axis histogram falls below the determined top region threshold, the top margin is taken to extend from the top of the image until the first row that falls above the threshold. Similarly, if the topmost row of the y-axis histogram falls above the determined top region threshold, the top margin is taken to extend from the top of the document image 400 until the first row that falls below the threshold. The bottom margin is computed similarly using the bottommost row of the y-axis histogram and extending upwards.

The x-axis histogram is similarly divided into 3 equal regions representing the left, middle, and right of the image. A threshold is calculated for the left and right regions independently using Otsu's algorithm. If the leftmost column of the x-axis histogram falls below the determined left region threshold, the left margin is taken to extend from the left of the image until the first column that falls above the threshold. If the leftmost column of the x-axis histogram falls above the determined left region threshold, the left margin is taken to extend from the left of the image until the first column that falls below the threshold unless the margin width would exceed image_width/4, in which case the document is determined to have no left margin. Finally, the left margin is extended to include the space up to the next column of the x-axis histogram that falls above the determined threshold if this additional space is less than 0.05*image_width in width. The right margin is calculated similarly, with the margin extending from the rightmost edge of the image leftwards.

From the top, bottom, left and right margins the ROI is computed as the interior rectangle extending from the top margin to the bottom margin and the left margin to the right margin of the image. Foreground pixels that lie outside the ROI are retagged as background pixels to exclude them from further processing.

Line segmentation by smearing. Line segmentation is the process of grouping foreground pixels together into logical lines such that each line represents a collection of characters or words that lie in the same horizontal region and are logically related to one another. In one embodiment, a line of text in a book forms a logical line for the purposes of segmentation. In another embodiment, individual prices on a restaurant check map to logical lines, and their corresponding item descriptions form separate logical lines for the purposes of segmentation. The disclosed method computes the line segmentation by smearing pixels in an input document image 400 horizontally to form regions of connected pixels 410, shown in FIG. 5, and then marking each connected region as a logical line segment 420, shown in FIG. 6.

First, a copy of the document image 400 is processed using the morphological dilation operation, and its connected components are labeled. Components taller than image_height/15 are ignored for the purposes of smearing. Next, the image is traversed by rows and pixels in each row are smeared from left to right as follows: If the distance between a foreground pixel and the next rightward foreground pixel in its row is less than a value ‘f’ times the pixel's connected component height, then the two pixels are connected by marking the pixels between them as part of the foreground 401. In one embodiment, the value of ‘f’ is taken to be 2.3. The same procedure is then carried out on another copy of the dilated image for each row from left to right, producing two smeared images of the dilated input image. These images are combined such that a pixel is tagged in the foreground 401 of the combined image if and only if it is tagged in the foreground 401 of both smeared images. The connected components of this combined image are then mapped back to the pixels of the document image 400 such that if two pixels in the input image correspond to the same connected component in the combined image, they are tagged as belonging to the same line segment 420.

Next, a post-processing step splits line segments 420 that are joined vertically by only a small bridge of pixels and should logically be considered two separate segments. Each line segment 420 is separately analyzed and projected by row onto the vertical (y) axis to compute a histogram such that the value of each row in the histogram is equal to the number of foreground pixels in that row of the line segment 420. The histogram is smoothed using a 1-dimensional Gaussian blur and analyzed to find valleys. Any valley of sufficient depth is understood to represent a small bridge of pixels connecting two logically distinct vertically aligned line segments 420 and the line segment 420 is then split into two.

Similarly, extraneous pixels above or below a line segment 420 are identified by analyzing the y-axis histogram computed above to find areas of value less than ‘pf’*max(histogram) over at least ‘h’*segment_height pixels at the top or bottom of the segment. In one embodiment, the value ‘pf’ is taken to be 0.33 and the value ‘h’ is taken to be 0.20. Such regions of pixels are marked as part of the background and the segment is shrunk to exclude that region.

Finally, line segments 420 that are either significantly large or small compared to the mean are understood to represent noise and are marked as part of the background.

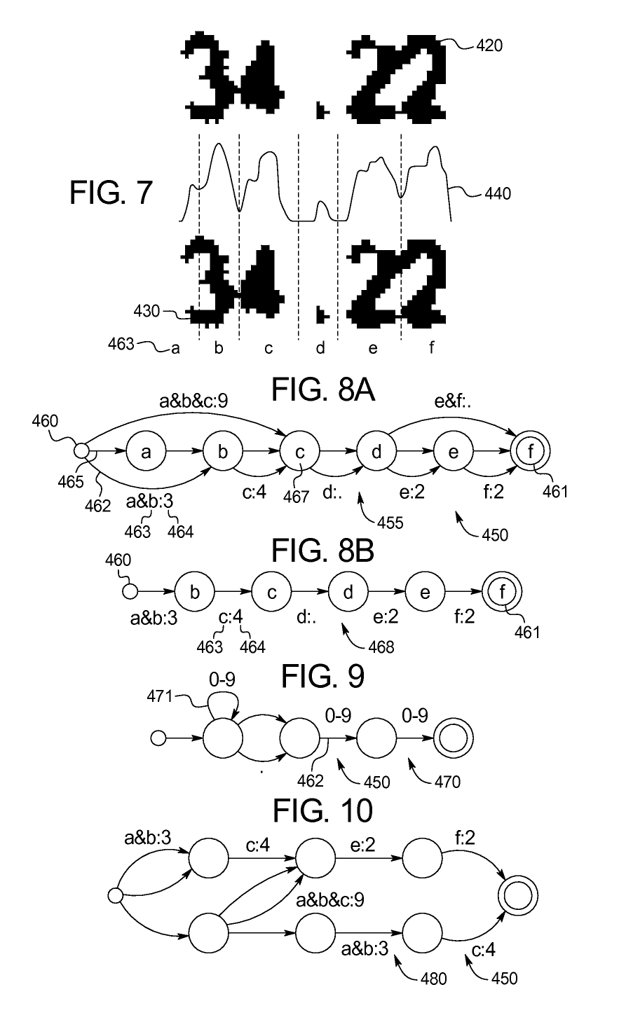

Character segmentation by projection. As shown in FIG. 7, it is necessary to further split each line segment 420 into one or more character segments 430 that each consist of a group of pixels representing part or all of a textual character. The disclosed method accomplishes this by analyzing a line segment 420 in order to compute vertical boundaries between horizontally adjacent characters. The described method intentionally computes an over-segmentation of the line segment so that any two logical characters in the line are guaranteed to be separated into two or more character segments 430. As a side-effect, a single logical character might also be segmented into more than one character segment 430; this situation is handled by grouping during classification, described later in the document.

First, a histogram 440 is computed by projecting the line segment onto the horizontal (x) axis by analyzing the line segment column-wise, setting the value of the histogram 440 for each column equal to the number of foreground pixels in that column. Then, the histogram 440 is analyzed to find all valleys of sufficient depth. If any two valleys are found to be too close together in the histogram, only the deeper of the two is considered.

To show the separation of each character segment 430 in FIG. 7, a vertical line is drawn through the line segment 420 corresponding to each valley in the histogram to denote the boundary between character segments 430. Note that connected logical characters as illustrated in FIG. 7 are correctly identified by distinct character segments 430, while some single logical characters are over-segmented into multiple character segments 430.

Grouping, space estimation, and classification of character segments. A character classifier is a component that takes as input the image pixels corresponding to a single character segment 430 or group of adjacent character segments 430, and outputs zero or more tuples consisting of a textual character and a corresponding confidence value indicating the computed likelihood that the character is an accurate representation of the input. Numerous character classifiers are known in the art, and one example is the Multi-Layer Perceptron (MLP), a type of artificial neural network.

Since the process of character segmentation described earlier produces an over-segmentation of the line segment 420, meaning that some logical characters may be represented as two or more character segments 430, it is necessary to run the character classifier on all possible groupings of character segments 430 in order to guarantee that the classification tuple corresponding to the logically correct grouping appears among the output.

One aspect of character segment grouping is estimating the likelihood that a gap between adjacent character segments 430 corresponds to a logical space in the line segment's textual representation. This is accomplished by marking any gap of at least width f*line_height pixels as a possible space and setting its likelihood value proportionate to the value of gap_width/(f*line_height). In one embodiment, the value of ‘f’ is taken to be 0.275.

Grouping is accomplished by examining each character segment 430 in turn, and building an ordered list of character segments 430 to the right of the character segment 430 which terminates at either the next space, the end of the line, or when a maximum length has been reached. Every sub-list of this list consisting of the leftmost element and adjacent elements is taken as a valid grouping and passed as input to the character classifier. For example, a line's character classification might consist of character 5 character segments spaced “abc de”. This yields 8 groupings: (a, ab, abc, b, bc, d, de, e), each of which is processed by the character classifier as input in order to yield zero or more classification tuples.

Construction of classification FSTs for each line. The output of character classification is represented using a Weighted Finite State Transducer (wFST or just FST) 450, which is a type of Finite State Machine with weighted transitions and separate input and output tapes. A simplified example wFST 450 is shown in FIG. 8a. A wFST 450 has a start state 460, as represented by a solid dot, and one or more final states 461, as illustrated by a double-circle. A wFST 450 is said to accept a sequence of input values 463 if a corresponding sequence of transitions 462 between states 467, called a path 468, can be taken from the start state 460 to a final state 461 such that the input label 463 of each transition 462 matches the next input label 463. FIG. 8b shows one example path 468 in the wFST 450 shown in FIG. 8a. A wFST 450 is said to transduce an accepted input into some output by emitting the corresponding output label 464 for each transition 462 in an accepted path 468. A special character, ε, may appear as either the input label 463 or output label 464 of any transition 462. As an input label 463, ε indicates that the transition 462 may be taken without consuming an input value 463. As an output label 464, ε indicates that the transition 462 does not emit any output label 464 when appearing in an accepted path 468. Note that FIG. 8 is simplified for purposes of illustration: Transition weights are omitted, and the unlabeled transitions 465 have an implicit input label 463 corresponding to the target state 467, and the output label ε. For example, the leftmost unlabeled transition 465 has input ‘a’ and output ‘ε’.

A line wFST 455 is a wFST 450 that is constructed for each line segment 420 to represent the output of character classification for all groupings of character segments 430 in that line segments 420. FIG. 8a illustrates an wFST 450 for an example line segment 420, shown in FIG. 7, representing the textual string “34.22”. This line segment 420 is further divided into 6 character segments 430 (a-f). Line wFSTs 455 have, in their simplest representation, one state per character segment 430. Each character segment group classification tuple is represented as a transition 462 in the line wFST 455 from the state 467 corresponding to the leftmost character segment 430 in the grouping to the state corresponding to the rightmost character segment 430 in the grouping. Note that some groupings may have multiple classification tuples, and thus transitions 462 in the line wFST 455, while others have none. Each transition 462 in the line wFST 455 has as its input label 463 a symbol corresponding to the grouping it represents, and an output label 464 equal to the character in the line classification tuple it represents. Its weight (not shown in FIG. 8a) is proportional to that tuple's confidence value.

For example, in FIG. 8a character segments a, b, and c are adjacent to each other and separated from segment d by a space, so they are grouped in 6 ways: (a, ab, abc, b, bc, c). Of these groupings, ‘ab’ is classified as the number ‘3’, ‘abc’ is classified as the number ‘9’, and ‘c’ is classified as the number ‘4’. The character classifier did not produce any classification tuples for group ‘bc’, for example, so no transition 462 exists. It is clear to an observer that the correct classification of characters a, b, & c is indeed (ab:3, c:4) and the line wFST 455 does contain multiple paths 468 that include those two transitions 462. Finally, unlabeled transitions 465 are added for each single character segment group with an output symbol of ‘ε’, which allows that segment to be omitted from valid paths 468 in the case that it does not represent textual information. For example, a smudge on the document may result in an extraneous character segment 430 in some line that should be ignored in valid paths 468. These transitions 462 appear as unmarked arrows in FIG. 8 as discussed above.

Choosing the correct path in a line wFST 455 is equivalent to finding the most accurate textual representation of that line segment 420, and is accomplished using a novel modeling system disclosed in the sections to come.

Filtered wFSTs. When analyzing documents containing structured data, the accuracy and performance of recognition can be improved by applying a line filter 470 that excludes any paths in each line wFST 455 that do not match the structure expected of that line segment 420. For example, when processing structured numerical data, paths 468 in a line wFST 455 that do not output a numerical interpretation can be excluded in advance of any further modeling. One embodiment of this method that is useful to the analysis of structured financial data is filtering line interpretations that do not match known formats for prices in a given locale and currency.

As shown in FIG. 9, a line filter 470 may be a wFST 450 that only accepts input values 463 matching the structure expected of a line segment 420 in the domain of the document being analyzed. An individual document may contain lines of more than one expected structure, and some lines may not be expected to conform to a pre-determined structure at all. Each line wFST 455 being analyzed is composed with the appropriate line filter 470 for its expected structure, if any, and the resultant filtered line wFST 480 contains only paths 468 from the line wFST 455 that match the expected structure of that line.

A simplified example line filter 470 is depicted in FIG. 9 which matches only inputs that have the structure of a typical price on a restaurant receipt in the United States. In this example, prices are expected to have the form equivalent to the regular expression: “̂\d*\.?\d{2}$”. Inputs “12.34”, “1 23”, “0.12”, and “12” are accepted by this wFST, whereas inputs “12.3”, “1 2”, “0.1”, “1”, and any input containing non-numeric characters besides “.” would be rejected and filtered. For clarity, the transitions 462 in FIG. 9 labeled “0-9” represent multiple transitions 462 for each of the numerals between zero and nine, where each transition 462 accepts and emits the same numeral (0:0, 1:1, 2:2, etc.). Additionally, the looping transition 471 represents multiple transitions 462 and may be interpreted as representing zero or more digits.

FIG. 10 shows the result of composing the line wFST 455 from example shown in FIG. 8a and the line filter 470 from FIG. 9, resulting in a filtered line wFST 480 containing only paths from the line wFST 455 that are accepted by the line filter 470.

In the disclosed system, line filters 470 also serve to adjust the weights of paths in a line wFST 455 during composition in order to increase the likelihood of choosing an interpretation that fits the line structure better than others, or to reduce the likelihood of choosing a path 468 that fits the structure poorly. In the aforementioned example, inputs where the “.” character is present to separate the dollar columns from cents columns might be weighted higher without excluding lines missing “.” from matches entirely.

Document modeling. The following disclosure improves OCR accuracy for document images 400 containing structured data by constructing a document model wFST 500 from filtered line wFSTs 480 and then solving the document model wFST 500 to find the path of lowest weight, which corresponds to the highest quality textual interpretation of the document image 400. Specific examples are provided from which the inventive solutions provided herein can be understood. While described with reference to specific details, the examples used herein are not meant to be limiting in nature.

Many documents contain structured numerical data comprised of one or more numbers, an explicit or implied mathematical formula specifying the relationship between numbers, and a numeric result. The modeling process then consists of constructing a document model wFST 500 out of the filtered line wFSTs 480 corresponding to each numeric value and the result value, such that all accepted paths 468 in the document model wFST 500 correspond to valid solutions to the associated formula for some combination of accepted paths 468 in the numeric lines and result value line. The path 468 of lowest weight in the document model wFST 500 is taken to correspond to the best solution to the model and the most accurate interpretation of the document text. Note that the best solution to the document model may yield an interpretation of individual lines that do not correspond to the lowest weight paths 468 in their individual line wFSTs 455, but instead incorporates the context of the document through its known structure to find a solution of globally, rather than locally, lowest weight.

In one embodiment, structured numerical data appears in a financial document such as a receipt, invoice, or bank statement. Each item in the document is printed next to its price, and the sum of these prices is printed in a total 550 or sub-total 530. In this example, the associated mathematical formula is: Sum(Item prices)=Total, and is implied by the nature of the document. More complex documents may contain multiple sections with sub-totals 530 that together sum to a document total 550. In this case, the document model would represent a system of equations.

Document layout analysis. The first step in document modeling is analyzing the layout of the document to determine which lines to include and how those lines should be related in the model. The position, size, and orientation of lines in the document are compared against the structure of known document type templates. Each template encodes the relationship between lines in that document type, and those relationships determine the structure of lines in the model of the actual document being analyzed. In some embodiments, the document type may be known in advance and the step of selecting the appropriate layout template is omitted.

Column finding. Structured numerical data is often organized in columns, where lines appearing in the same column indicate a mathematical relationship between the numbers they represent. Receipts, invoices, and other financial documents, for example, typically arrange item prices in a column that sums to a total 550, printed at the bottom. For this reason, column finding is an important step in the layout analysis of many document types.

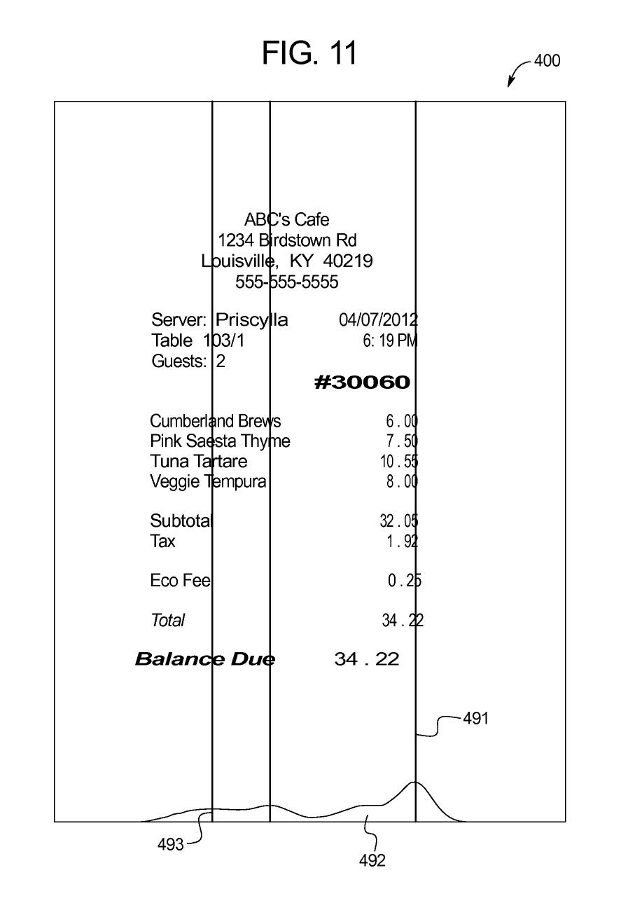

FIG. 11 is an example of column finding in a document image 400 of a receipt. The disclosed method groups document lines into columns by computing the x-axis histogram 492 of the location of their aligned edges. The aligned edge depends on the structure of the document, as well as conventions particular to the language and writing system in the document's locale. Receipts in the United States, for example, typically feature right-aligned numerical columns, so column finding is performed using the rightmost edge of each line. Next, the histogram 492 is smoothed with a gaussian blur and its peaks 493 are computed. Each peak 493 is taken to correspond to a column of text in the document, and each document line is marked as belonging to the column whose peak is horizontally closest to its aligned edge.

Total estimation. Some documents that may include one or more columns of numbers that sum to a provided total, for example, a receipt. While many documents will not fit into this category, it is useful to explore techniques that can be implemented for these documents. When analyzing documents where one or more columns of numbers sum to a provided total, it is necessary to determine which line represents the total in order to build an accurate model. The disclosed method takes as input a column of tuples, each tuple consisting of a line segment 420 and the corresponding filtered line wFST 480, and produces a ranking of lines from most to least likely to represent the total of that column. For each tuple, the filtered line wFST 480 is examined to produce:
(a) The weighted average of the numeric interpretation of all paths in the filtered line wFST 480, weighted by the inverse of their path weight
(b) The logarithm base 10 of the value calculated in (a)
(c) The weight of the most likely numeric path in the filtered wFST
(d) The intermediate value: (1−(c)/10)̂2
(e) The intermediate value: log 10(line segment width)/log 10(document image width)
(f) The intermediate value: min(1.0, 10*(line segment height)/(document image height))
(g) The intermediate value: ((column #+1)/(# columns))̂3
(h) The intermediate value: 1−(bottom edge of the line segment)/(image height)
(i) The total ranking value: (b)*(d)*(e)*(f)*(g)*(h)

The input tuples are then sorted by their corresponding total ranking value in descending order to yield a list of document lines sorted from most to least likely to represent the column total.

Guided layout analysis. In the disclosed method, input from external sources, such as a human user, can be incorporated into the process of document layout analysis in order to improve its speed or accuracy. In one embodiment, the user indicates which document lines to include in the model by drawing a rectangular region on a touchscreen device. Lines that fall at least partially within this rectangle are included in the model, while any that fall entirely outside the rectangle are excluded from the model. In another embodiment, the user indicates one or more regions of the document that contain lines with a high probability of inclusion in the model solution. The zero-path weight of is increased in these lines, which subsequently increases the likelihood that those lines are non-zero in the lowest weight solution path. In yet another embodiment, the user indicates which line in the document corresponds to the total. The total ranking value for this line is then set above all others, moving it to the top of the ranking.

Model construction. In the case of documents containing a list of numbers that sum to a provided total, the document model wFST 500 is constructed from one or more filtered line wFSTs 480 yielding numeric output, the filtered line wFST 480 corresponding to the numeric total, and an adder wFST 570 that accepts only inputs that represent a list of numbers summing to zero. When the line representing the total value is not explicitly known, the method disclosed above is used to produce an ordered list of likely totals and a model is constructed for each candidate. In one embodiment, all models this group are evaluated and the solution of lowest total weight is chosen. In another embodiment, models are evaluated in the order of their respective total rankings and the first solution is chosen.

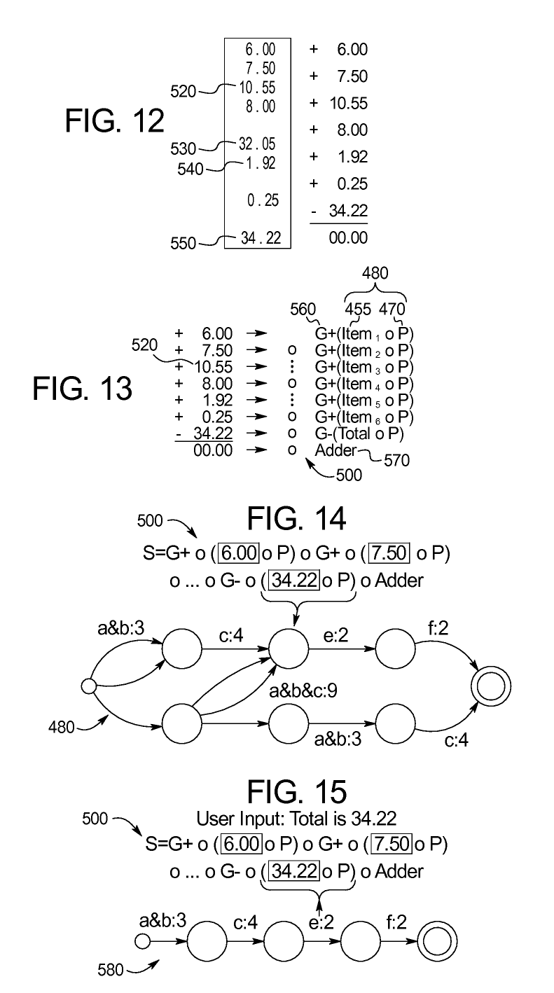

FIG. 12 depicts an excerpt of an example restaurant receipt with item prices 520, a sub-total 530, taxes 540, and a total 550. This type of document is modeled by the implicit equation: Sum(Item prices)+Sum(Tax)=Total, which can be re-written as: Sum(Item prices)+Sum(Tax)−Total=0. FIG. 13 shows the same example as FIG. 12 at left, and an illustration of the construction of the document model wFST 500 on the right. Each item price 520 in the receipt document is represented by a glued line wFST 560 which is the result of a glue function applied to the filtered line wFST 480 appearing horizontally adjacent to the item price 520 in the example. The glued line wFST 560 is constructed beginning with the line wFST 455 labelled Item(i). The line wFST 455 is composed with a line filter 470 labelled P to yield a filtered line wFST 480. Then, the filtered line wFST 480 is processed by the glue function, labelled G+ or G−, depending on whether that price item 520 is to be added or subtracted in the model, in order to yield a glued line wFST 560 for that line. A glued line wFST 560 is constructed for all lines in the model, and all glued line wFSTs 560 are composed together with the adder wFST 570 to form the completed document model wFST 500.

All accepted paths 468 in the document model wFST 500 correspond to valid solutions to the document model wFST 500. In this example, all item prices 520 and taxes 540 sum to the total. Also, since the document model wFST 500 is constructed from individual line wFSTs 455 that were in turn constructed from the weighted output of character classification, the weight of each path in the document model wFST 500 is a measure of its likelihood of representing an accurate textual interpretation of the document as a whole. Therefore, the lowest weight path accepted by the document model wFST 500 is taken to be the highest quality textual representation of the document's structured numerical data.

The Adder wFST. The adder wFST 570 is constructed to take as input a sequence of numbers in a particular format and accept only those that sum to zero. Each numerical input is separated into a sequence of digits and each digit is prefixed by a by ‘+’ to indicate addition, or ‘−’ to indicate subtraction from the running total. Addition and subtraction are performed by column, beginning with the least significant digit of each input number and proceeding towards most significant. In order to facilitate column-wise processing, the input is formatted such that all digits appearing in the n-th column of any number are grouped and appear together in the input sequence. A special input character, ‘#’, marks the end of a column, where the running total must be divisible by 10 or the input can never sum to zero and is immediately rejected. If the column total is divisible by 10, the column total divided by 10 is computed and carried as the initial value for next column's running total. This process continues from least to most significant column until all input columns are exhausted. If the total of the final column sums to zero, the input is accepted.

The adder wFST 570 represents a number line ranging from some minimum value x<=0 to maximum value y>=0 with one logical state per integer between x and y. In one embodiment, the value for y is calculated as 9 times the maximum number of input characters to appear in any column, and x is taken to be −1*y. Each logical state on the number line corresponds to the current value of the running sum for the input column being processed. The start state represents a running sum of ‘0’, and is also the only final state in the adder wFST 570 since only inputs summing to 0 are accepted.

Each logical state on the number line has transitions representing the addition or subtraction of an input value from the current running sum. For example, there is a transition that logically represents “+1” between the states representing “1” and “2”. Similarly, a logical transition representing “−3” exists between the states representing “2” and “−1”. Each logical transition is actually two transitions in the adder wFST 570 with an intermediate helper state. The first transition consumes the “+” or “−” symbol, and the second consumes numeric input symbols between 0-9 and terminates at the corresponding state on the number line.

Transitions consuming the special end-of-column symbol ‘#’ may connect logical states representing each number z, divisible by 10, to the state representing z/10. If the current running sum is not divisible by 10 at the end of column, no transition labelled ‘#’ is present and the input is rejected.

Glue function. A glue function is applied to each filtered line wFSTs 480 in the document model wFST 500 such that when all glued line wFSTs 560 are composed with one another, the resulting output is in the input format required by the adder wFST 570 as shown in FIG. 13. Specifically, the numeric output of all composed filtered line wFSTs 480 must be interleaved so as to appear in column order from least to most significant digit. Each digit must be prefixed by ‘+’ or ‘−’ to indicate whether that line is to be added or subtracted from the document model wFST 500, and the end of each column in the interleaved input may be marked with a special end-of-column character, which may be represented with ‘#’.

The process of applying the glue function to a filtered line wFST 480 entails replacing all transitions 462 emitting numeric output in the filtered line wFST 480 with a small glue wFST. The structure of the glue wFST applied to a particular line wFST 480 depends on two factors:
(a) Whether the line is the first line in the model
(b) Whether the line is to be added or subtracted from the model

Each of the aforementioned factors may be true or false, yielding four glue wFST templates. Each template may be further modified by replacing the output with the actual numeric output character in the line wFST 480 transition being replaced. For example, when replacing a transition emitting the output ‘4’, which is to be added to the running sum, the template output may replaced by the character ‘4’.

Excluding lines from the model solution. When constructing a document model wFST 500 from the results of layout analysis, it is often difficult to separate lines that belong in the document model wFST 500 from those that do not. Column headers, extraneous noise, or other unrelated textual information may resemble potential model lines and fit with the known or computed document layout. Furthermore, it is essential to guarantee inclusion of all legitimate model lines in order to produce the logically correct document solution. For this reason, layout analysis is tuned to minimize false negatives at the cost of including false positives, and the document model wFST 500 itself is structured to produce solutions that include only the logically correct lines while excluding extraneous input.

For the case of modeling structured numerical data representing a collection of numerical lines that sum to a provided total, non-model lines are excluded from the model solution when their output value in the solution path is equal to zero. This can happen whenever the filtered line wFST 480 contains a path that outputs zero, called the zero-path, and the likelihood of a line's exclusion from model solutions corresponds inversely to its zero-path weight. The disclosed method adds a new zero-path to model line wFSTs and sets its weight by computing a quality score for each line wFST 455 based on its properties and properties of the model as a whole:
(a) Compute the weighted average of the model total wFST's numerical paths
(b) Compute the weighted average of the analyzed line wFST's numerical paths
(c) Find the weight of the most likely path for the wFST being analyzed. This is the path corresponding to the most likely numerical value
(d) Compute the intermediate result: 250*(50̂(5.0−(c))/50̂5)
(e) Calculate the intermediate result: if (a)>0: max(5*(1−(b))/(a), 0), else 0
(f) Calculate the intermediate result: 25*(0.5−abs((line height)/(document image height)−0.5))
(g) Compute the quality score: 0.5*(2+max(0, (d)+(e)+(f)))
(h) Set the weight of the new zero-path to: (c)+(g)

A* heuristic search. Once a document model wFST 500 of the document's structured data has been constructed, it is analyzed to find the path 468 of lowest weight, which corresponds to the most accurate interpretation of the document's textual data. In one embodiment, the disclosed method does this efficiently by using the A* (A-star) search algorithm with a heuristic calculated at each state in the document model wFST 500 as a lower bound of the weight for any path 468 from that state 467 to a final state 461.

If n lines are included in the document model wFST 500, then the document model wFST 500 is composed from (n+1) wFSTs 450; one per glued line wFST 560 plus the adder wFST 570. Then each state in the document model wFST 500 logically corresponds to an (n+1)-tuple consisting of the identities of logically associated states 467 in each of the (n+1) composed wFSTs 450.

In order to calculate the search heuristic at a state 467 in the document model wFST 500 efficiently, first the lower bound path weight is calculated for each state 467 in each of the individual component wFSTs 450 that are composed together to build the document model wFST 500. Then, for each state 467 in the document model wFST 500, the heuristic is calculated as the sum of the lower bound path 468 weights for each of the (n+1) corresponding states in the individual component wFSTs 450.

Handling corrections & model input. Input or corrections from external sources, such as a human user, can be incorporated into the model to improve accuracy and performance. External input is incorporated into the document model wFST 500 by modifying its structure or the contents of its component filtered line wFSTs 480 in order to either add paths 468 indicated by the external source, or to remove paths 468 that external information indicates are not part of the best solution. Many types of external input can be incorporated into the document model wFST 500 depending on the document type. For the case of structured numerical data consisting of a collection of items that sum to a provided total, types of external information include, without limitation:
(a) The known value for a line
(b) An indication that a line's value is non-zero in the best solution
(c) The identity of the line corresponding to the model total

Input of type (a) is incorporated into the document model wFST 500 by replacing the indicated line's filtered line wFST 480 with a single-path wFST that outputs the specified value. FIG. 14 depicts a simplified document model wFST 500 (top) and the expansion of the filtered line wFST 480 corresponding to one of its component lines (bottom). In this example, the filtered line wFST 480 has 5 paths, and so the document model wFST 500 permits 5 possible values for that line in its solutions. FIG. 15 shows the same document model wFST 500 where a user has provided input of type (a) indicating that the selected line's actual value is “3422”. The generated single-path wFST 580 is shown below and substituted into the document model wFST 500 to yield only one possible value for the line, known to match the user's input, in the model solution.

Input of type (b) results in modification of the indicated line's filtered line wFST 480 to remove any zero-paths, including those inserted using the method disclosed above, prior to inclusion in the document model wFST 500. Input of type (c) causes the total ranking of the indicated line to be set above any others, and the document model wFST 500 to be constructed with its filtered line wFST 480 as the total.

Manipulation of imported textual data. The method for high-accuracy OCR of structured documents disclosed above enables new applications for manipulation of structured textual data on computing devices, including mobile devices with a camera and touchscreen. First an image of a document is captured and imported into a computer for OCR analysis. The output of this analysis is a computer-usable textual representation of the document's content, separated into lines as described above. Next, the textual representation of each line is associated with the region of the image representing that particular line. After this association is made, any manipulations performed on the image representation of the document are also performed on the textual representation. Similarly, any modifications to the associated textual data are indicated in the image. This association comprises an image-based interface to the document's textual data that enables numerous applications.

Document manipulation using an image-based interface. In one application, a physical model is associated with the document image 400 and its corresponding textual representation. On a touchscreen device, the user may physically tap, touch, and drag to manipulate text in the document image 400. In one embodiment, words and sentences can be picked up on the screen and physically moved to re-order them in the textual document representation. The edited document text can then be emailed or printed.

In another application, a document containing structured numerical data is imported and analyzed to build a mathematical document model, as disclosed above. A physical model is then constructed to correspond to both the mathematical model and lines in the document image 400. Then, physical manipulation of lines on a touchscreen device results in modification and recalculation of the mathematical model. In one embodiment, numeric lines in each column sum to a total. Dragging a price line 650 from one column to another updates the respective column totals to reflect the addition/removal of the indicated number. In another embodiment, price lines 650 in a restaurant receipt are assigned to a collection of guests, each represented by an icon. Dragging an item from the receipt to a guests's icon indicates that the guest ordered that item, and their total, tax, and tip values are updated accordingly. After assigning all price lines 650 to guests, the user pays by initiating an electronic payment API request which is constructed from the associated textual representation. In yet another embodiment, a financial ledger containing purchase entries and a running balance is imported, and textual and physical models are constructed. The user then swipes to remove entries from the ledger, or drags to change their chronological order, updating the underlying textual representation and the running account balance. The edited document text can then be printed or exported in a format usable by financial software.

Accessibility applications. The disclosed image-based interface to a document's textual data enables a number of applications to facilitate access to the document by individuals with special needs. In one application, the document's associated textual representation is converted to audible speech and read out loud. The document's text may be read aloud along with additional information about the document's layout or structure extracted during image analysis and modeling. In one embodiment, a document containing structured numerical data is captured, analyzed, and its mathematical model is used to add context to its spoken representation. For example, “The document contains 3 items summing to $34.22.”

In another application, the image-based application is used to indicate which sections of the document's underlying textual representation to read out loud. For example, the user may tap on text in the document image to indicate that the computer should read that section of the document aloud.

In another application, the document's underlying textual information is translated to another language and regions of the image corresponding to text are replaced with the translation.

In yet another application, a document containing financial data is analyzed and its numeric lines are converted into an alternate currency. The document image is then modified to reflect this change to the underlying numeric representation.

Background estimation and foreground extraction. Background estimation is the process of replacing pixels in the foreground 401 of a document image 400 with a computed estimation of the background 402 at those pixel locations. For document image 400s, this technique conceptually removes text from the page and fills in the removed pixels so as to match the background 402, yielding an image containing only the page without text.

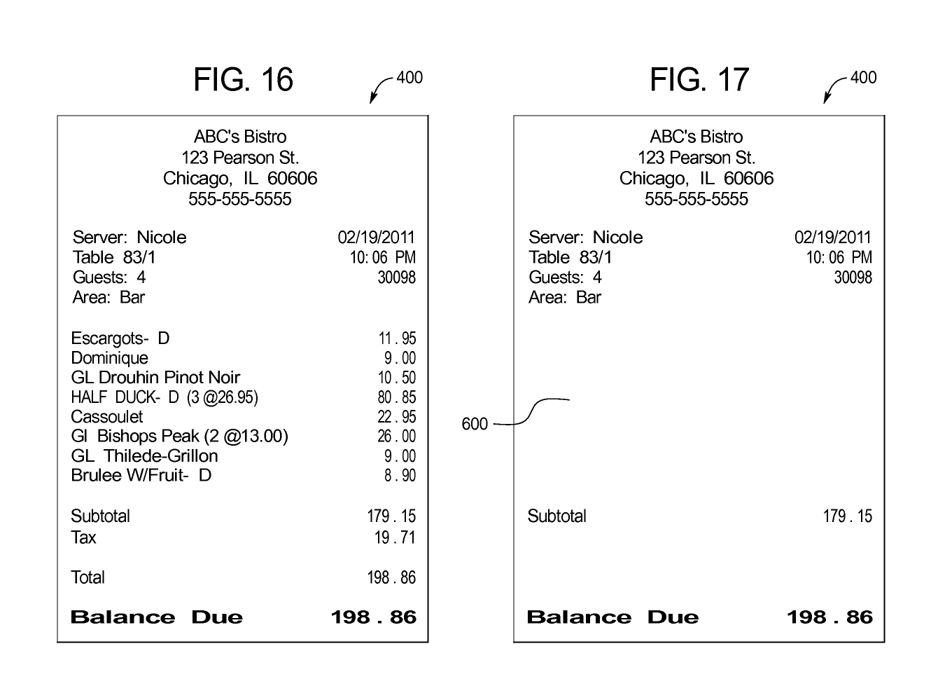

Background estimation and foreground extraction begins by identifying foreground pixels in an image using the process of binarization disclosed above. FIG. 16 illustrates an example document image 400 for use background estimation and foreground extraction. Then, some set of foreground pixels are chosen for extraction. In one embodiment, pixels corresponding to specific lines of text are chosen for extraction. For example, lines that are included in a model solution may be identified and their pixels may be chosen. For each selected pixel, a corresponding background pixel value is computed by calculating the average intensity in each color channel of the image in a rectangular neighborhood centered at the pixel, and excluding any foreground pixels. In one embodiment, the neighborhood is chosen to be 15×15 pixels in size. Finally, the computed background pixel is substituted into the image in place of the corresponding selected pixel. In one embodiment of this method, the median is used in place of the average when calculating the background pixel value. FIG. 17 illustrates the example of FIG. 16 with selected foreground text 600 removed and replaced by background estimation.

The disclosed approach provides improved efficiency by grouping nearby selected pixels into distinct regions, each bounded by a rectangle. Each region is analyzed in turn, and two integral images C and A are constructed for each color channel in the image: C representing the change in color and A representing the change in the number of included background pixels, or effective area. Using these two integral images, the average intensity can quickly be calculated for any rectangular neighborhood (x1, y1, x2, y2) in the region as: (C(x1,y1)+C(x2,y2)−C(x1,y2)−C(x2,y1))/(A(x1,y1)+A(x2,y2)−A(x1,y2)−A(x2,y1)). The average intensity values for each channel are calculated in this way, then combined to produce the corresponding background pixel, as above.

Collapsing document layouts. When displaying document images 400 on a device with a small screen, it is often impossible to show the entire document image 400 without rendering text too small to read comfortably. Many devices allow the user to zoom in to view a region of the document, at the cost of excluding surrounding context from view. The disclosed method introduces a better solution than traditional zooming by separating textual lines from the document background, then constructing a collapsable layout that allows whitespace to collapse during zoom in order to maximize the amount of text visible on screen.

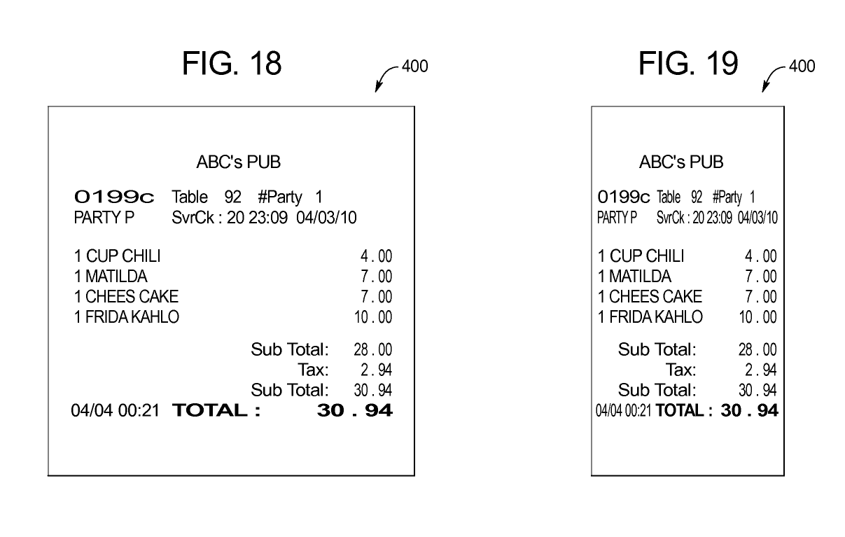

FIGS. 18 and 19 illustrate an example document 400 before and after collapsing the document layout. FIG. 18 shows an example original document image 400. FIG. 19 illustrates the document from FIG. 18 using a layout that retains text while eliminating extra whitespace between the columns. To collapse the document layout, the mobile device 100 performs the steps of: First, foreground pixels are identified and segmented into lines as disclosed earlier. Then, pixels included in a textual line are extracted from the image, and the disclosed background estimation technique is used to fill in the document page. A layout structure is constructed to represent the location of the extracted textual lines within the document, depending on zoom level identified by the parameter z.

When z=1.0, the document image is shown at its original size, and the layout structure defines the position of each line to be its original position in the document image. Similarly, when z<1.0, the document appears smaller than its original size, and the layout still defines each line to be its original position in the document. When z>1.0, the document is shown larger than its original size, and one area of the document is visible on-screen while the remainder of the document is excluded. In this case, the layout structure preferentially shrinks the whitespace surrounding document lines to avoid excluding textual information when possible. A pair of parameters limit the minimum size of each whitespace region to either an absolute width and height, or a percentage of the original size of that whitespace region. When a whitespace region has been shrunk to its minimum width or height, the layout structure must either shrink or exclude one or more textual lines, depending on a configuration parameter. Finally, textual lines are rendered over the background page in the position determined by the layout structure to yield an enhanced document image.

For certain document types the collapsable layout is configured to zoom in only the horizontal or vertical dimensions, rather than both directions, in order to preserve relative scale in the other dimension. In writing systems where text appears in horizontal lines, allowing zoom in only the horizontal direction maintains the vertical line spacing and readability of text while eliminating extra whitespace between columns and around the left and right margins of the page.

Resolution-independent drawing at multiple scales. When a region of a document image 400 is shown at a high zoom level, textual foreground features become pixelated or blurry, decreasing legibility. Resolution-independent drawing solves this problem by creating an enhanced view of the visible region with sharply rendered text, regardless of the resolution of the original document image. First, OCR is performed on the document image 400 using the methods disclosed above to yield a computer-usable representation of the document's textual information. Then, the foreground pixels corresponding to text within the visible region is extracted using the background estimation method described above. Finally, text is re-drawn over the background image at the appropriate zoom level in order to produce an enhanced image of the document image with sharper text. This method is resolution-independent, because sharp text can be rendered for any zoom level regardless of the resolution of original document image.

Check splitting using Optical Character Recognition on a mobile device. High-quality OCR of structured numerical documents enables a host of possible applications. The following disclosure elaborates on the previous disclosures above to describe one such application that enables the user to easily split a restaurant check among guests.

Conceptually, check splitting proceeds by the following steps (explained in greater detail below): First, a document image 400 of the check is captured. Next, OCR is performed and the user verifies that the OCR output matches the actual document, making any corrections if necessary. Then, each check item is assigned to a guest or group of guests by physically picking it up on a touchscreen and dragging it to a picture of the guest. Finally, guests are grouped together by party, and each party's total, tax, and tip values are shown.

Capture. The first screen in the application helps the user capture a high-quality image of their receipt. In a preferred embodiment, features such as level balance, low-light detection, skew detection, context-sensitive help, etc., are used to provide feedback and information to a user to help the user capture a document image 400 well-suited for OCR.

Level balance. When capturing an image for OCR, an image taken as parallel to the document as possible is essential for accurate character recognition, something which the user can oftentimes have a hard time judging on his own. A mobile device 100 may include onboard sensors for detecting physical orientation, such as positioning sensors 112 and mention sensors 108, can be extremely beneficial in obtaining a usable image for recognition. This information may be relayed to the user via a display superimposed atop the live image coming in from the phone's camera. Each side of the image may include a line with notches corresponding to different angles, with a triangle on each line pointing to the angle the device is currently being held at. In addition, a status indicator at the bottom of the screen may direct the user to tilt the device towards or away from them, until the triangles are as close to the center of each line as possible. The triangles may be green to indicate the device is being held at an acceptable angle, or may turn red when the viewing angle is outside of recommended tilt.

Low-light detection. Poor lighting reduces the quality of OCR output by introducing noise into the document image 400. The disclosed method detects low contrast conditions during capture and indicates to the user that additional light is necessary for optimal results. In one embodiment, a flash light is automatically illuminated when low light conditions are detected. First, a preview image is captured. Then the image contrast is calculated:
(a) Calculate the average intensity of all pixels in the preview image
(b) For each pixel in the preview image, calculate (pixel intensity−average)̂2
(c) Sum all the values from (b)
(d) Compute sqrt(c) to yield the preview image contrast

When the preview image contrast falls below a threshold value t, more light is required for optimal OCR results. In one embodiment, the value t is taken to be 30. In the best mode of implementation, the preview image is first sampled to yield a subset of pixels that are used as input to this algorithm, resulting in a performance improvement over examining all pixels in the preview image.

Skew detection. As discussed above, document images 400 captured at a skew reduce the quality of OCR output. The disclosed method reduces skew in captured document images 400 by detecting skew in a preview image and indicating to the user that the optical sensor 118 should be adjusted to reduce skew before capturing an image for OCR. First, a preview image is captured. Next, the skew detection algorithm disclosed earlier is applied to compute the amount of skew in the preview image. If the skew amount exceeds a threshold, the user is warned.

Context-sensitive help. The bottom of every screen in the application contains a button linking to context-sensitive help. A help context is associated with each state of the application, and the current help context is updated to reflect the current application state as the application state changes. When the help button is tapped, the help context is used to display a help screen that pertains to the current application context. Context-sensitive help gives an overview of each step in the app, allowing a first-time user to familiarize himself with all aspects of recognition.

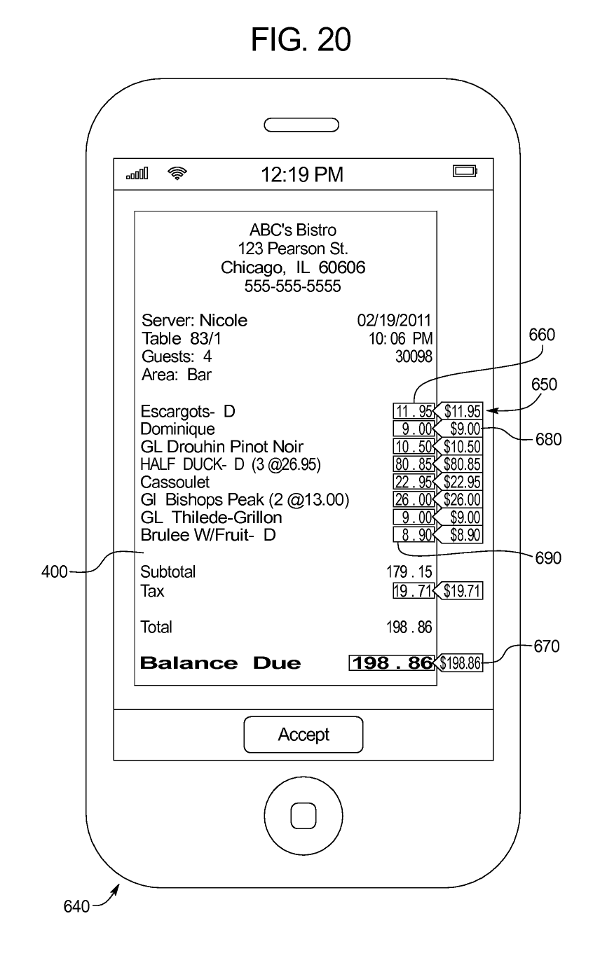

Classification. After the document image 400 has been captured, a classification screen 640 may be shown. FIG. 20 shows a screenshot of an example user interface displaying a classification screen 640. As shown in FIG. 20, the user may provide input to the OCR algorithm and verify that the resulting computer-usable representation of the receipt's price information is accurate. If any errors are found, the user provides additional input that is used to improve the model solution, as disclosed above.

Binarization overlay. Once the image has been captured, the first step is to binarize the document image 400, or attempt to separate the printed text on the document from the background, along with removing shadows or any other visual noise that might confuse the OCR engine. Seeing whether the receipt has been accurately binarized can be a useful early indicator to the user of whether or not a good image has been captured. Once binarization has been completed, the binarized data is overlaid on top of the document image 400 in a bright color making it clear what the software will “see” when it begins recognition. This brightly colored overlay is then faded back into the image to assist in comparing the binarized data to the actual content of the document.

Tap total. Once binarization is completed, the software moves on to identify which regions of the document image 400 represent price lines 650 using the line segmentation method disclosed above. As seen in FIG. 20, the price lines 650 of the document image 400 are identified with a gray highlighter-like background 660, indicating to the user both that this is text that has been recognized as a potential price, and an area that can be tapped for editing or manipulation. At this point, recognition may be paused and the user is prompted to tap the area corresponding to the bill's total 670. While the software is capable of determining which region is the bill's total 670, asking the user to indicate the correct total line results in a large increase in recognition accuracy.

Price indication and tags. Once the bill's total 670 has been indicated, the document model wFST 500 is solved to find the highest-quality interpretation of the check's prices. The device shows the user each region believed to correspond to a relevant price. Each price may be highlighted from behind in yellow rather than gray, and a small price tag icon 680 may appear next to it. The price tag icon 680 may include a price showing the most likely price. Also shown is a determined category icon 690. If a price or category is wrong, or a relevant price is being ignored and still highlighted in gray, the user can tap the region and bring up the price editing screen.

Manual price entry. The user is prompted to edit the price when a price line 650 is tapped. The manual entry screen prompts the user to enter the price, plus a category such as tax or tip, that may affect how the price is used in total calculation. Once a price is edited, OCR begins again, this time assuming the edited price region is accurate. The price area may be shown zoomed in on the top of the screen for clarity, with edit regions for the price's numeric value and category. Tapping either region will bring up its respective editing widget—a numeric keypad for the price (with the last two characters automatically set to a decimal value), or a selection menu for the category. At any time during classification, the user can zoom in to see detail on a certain region of the document image, or zoom out to see a larger region of the image in context. Resolution-independent drawing, disclosed above, may be employed to increase legibility of text at high zoom levels, and to show high-quality price tags.

Additional user input. In addition to manually indicating which textual line corresponds to the document's total, the user may be prompted to provide additional input in order to improve layout analysis and OCR, as disclosed above. In one embodiment, the user is asked to indicate textual lines corresponding to taxes 540, tip, or discounts. In another embodiment, the user is asked to draw a rectangular region that contains textual lines corresponding to prices in the check. Lines that fall outside this region are then excluded from the model.

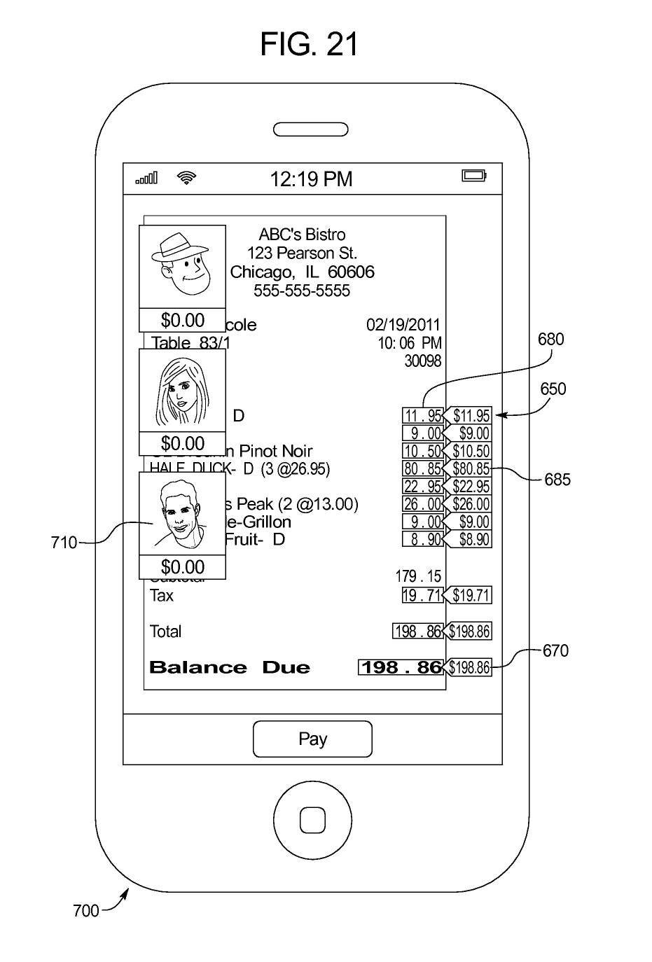

Assignment. When the user has verified that the OCR price output correctly reflects the receipt document, the assignment screen 700 is shown. FIG. 21 illustrates an example of an assignment screen 700 for use in splitting a check. As seen in FIG. 21, the user populates a list of guest icons 710 with photos or other images that represent the guests that wish to split the check. Then, the user assigns each price item on the check to the guest that ordered that item, or splits an item among some group of guests. When all price lines 650 have been assigned, the group is ready to pay.

Collapsable check view. The main element on the assignment screen is a view created using the procedure disclosed above to build a collapsable layout from the captured receipt image. In this embodiment, the layout collapses whitespace in only the horizontal direction, leaving line spacing and text height unchanged. When collapsed, the item names are shown preferentially and item prices 520 are excluded from the view, allowing more of the item name to be visible at a higher zoom level. Collapsing the view triggers calculation of an appropriate zoom level, z, that maximizes the amount of text visible while ensuring that each textual line is tall enough to comfortably tap and drag. In one embodiment, z is cad in a manner similar to FIG. 19, the scrolling is disabled in the horizontal direction but enabled in the vertical direction, for ease of use.

At any time when the assignment view is not collapsed the user can zoom in to see detail on a certain region of the document image 400, or zoom out to see a larger region of the document image 400 in context. Resolution-independent drawing, disclosed above, is employed to increase legibility of text at high zoom levels, and to show high-quality price tags.

Guest management. Each paying guest is represented along the side of the screen with a guest icon 710, and a price underneath indicating the current total of items assigned to them. In some embodiments, tapping an “Edit Guest” button on the bottom toolbar will make the assignment screen enter guest management mode, where guests can be added or deleted.

Upon entering guest management mode, the screen moves into an editing mode. The guest icons 710 for existing guests begin to wobble, indicating that they can now be edited. Guest icons 710 can be dragged to reorder their position in the list, or the close icon in their top-left corner can be tapped to remove them. If the user attempts to delete a guest that already has items assigned, the user is prompted with a dialog box confirming the guest should be deleted. If the user answers in the affirmative, the guest is deleted, any items assigned to the guest are unassigned, and totals for any items that may have been split between this guest and others are updated accordingly. In addition, a dialog appears covering the receipt that allows the addition of new guests. A guest's icon can be selected from one of the photo albums on the mobile device 100, if present. When an existing contact is chosen, associated electronic payment information is used during the payment phase. When choosing guests from these sources a scrollable list of thumbnails is drawn, and dragging any thumbnail icon onto the guest list will insert a new guest in that location. In addition, tapping or dragging a cartoon guest icon will randomly give it a colored background, to more easily differentiate guests during assignment.

As a final method of adding guests, the software includes a “QuickPic” mode which allows capture of a guest's image using the device's built-in camera. A photo preview indicator is displayed with a large “Add Guest” button underneath. By sweeping the camera around the table and quickly tapping “Add Guest”, the user can add images of everyone that will be splitting the bill. If the device has a user-facing camera, the user can also flip the view to use this, allowing the user to add him or herself to the guest list quickly.

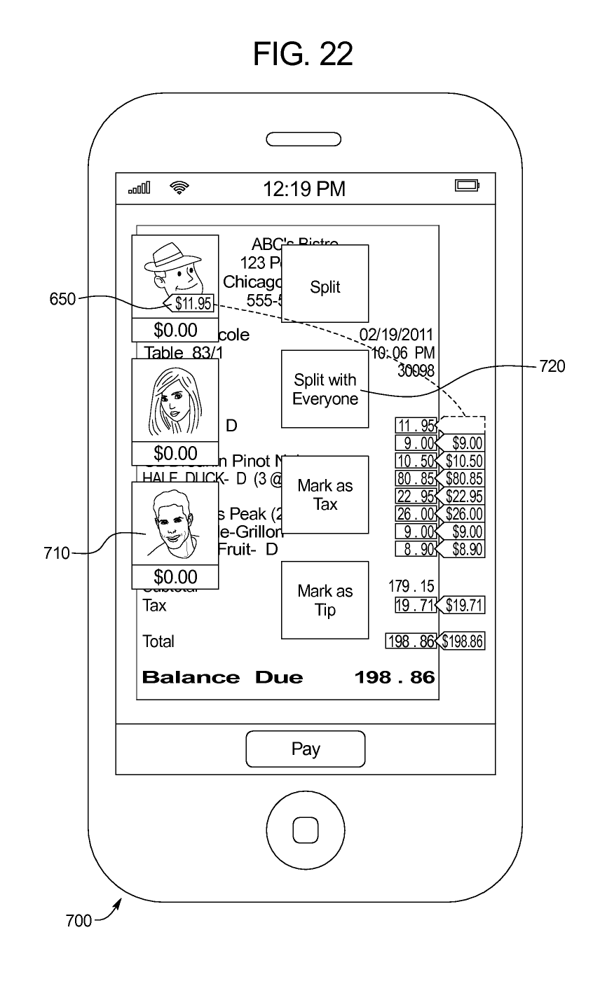

Item assignment. To assign a price, the user taps and holds the price line 650 to pick it up, then drags it to the guest icon 710 where it should be assigned. This dragging can be seen in FIG. 22, where the price line 650 has become enlarged and the highlighted portion is now moving freely under the user's finger. There are several potential destinations for assignment. The most obvious is to a guest—dragging a price line 650 on top of a guest icon 710 on the side of the screen causes the icon to be highlighted and enlarge slightly. When the user lifts their finger, the price line 650 is assigned to that guest, whose total underneath their guest icon 710 is updated accordingly. If the price line 650 was previously assigned to a different guest, it is unassigned from them and their total is similarly updated. If the guest icon 710 consists of a predefined cartoon icon, an animation in the icon is triggered to reinforce which guest has been selected. In addition, the drag bar icon 685 to the right of the item's price tag is replaced with a smaller icon of the guest to which it has been assigned.

In addition to the guest icons 710 on one side of the screen, a group of special assignment categories 720 are drawn on the opposite side when price dragging begins. These special assignment categories 720 appear in a popup animation designed to catch the user's attention at the moment dragging is started. Each special assignment categories 720 allows an action to be taken on a price other than simply assign to each guest's total.

“Split,” on the other hand, brings up a screen with a list of guests, a total next to each one (starting at $0.00), and a series of grayed-out indicator icons. Every time a guest is tapped, one of the guest's indicator icons is highlighted, the item being split is divided into one more piece, and the new piece is assigned to that guest, updating the total. For example, if an item totaling $9 is dragged onto the “Split” button and Guest A is tapped, one of Guest A's indicator icons becomes highlighted and the entirety of the $9 item is assigned to him. Tapping Guest B will divide the item into two pieces, assigning the second half to Guest B, so that Guest A owes $4.50 and Guest B owes $4.50. A third tap on Guest B will similarly divide the item into three pieces, with Guest A owing $3 and showing one indicator icon highlighted, and Guest B owing $6 with two highlighted. Tapping a guest repeatedly, with all five indicator icons being highlighted, and then tapping again, will “roll over” the assignment for that particular user, setting their share back to 0 and updating everyone else's totals accordingly, to allow for correcting of assignment mistakes.

“Mark as tax” and “Mark as tip” each serve a similar purpose, to mark this particular receipt item as something other than a specific item price. “Tax” corresponds to sales tax, and “Tip” is used if a venue has added a predetermined tip to the bill. Each is divided and assigned to each guest on the final screen based on their portion of the bill.

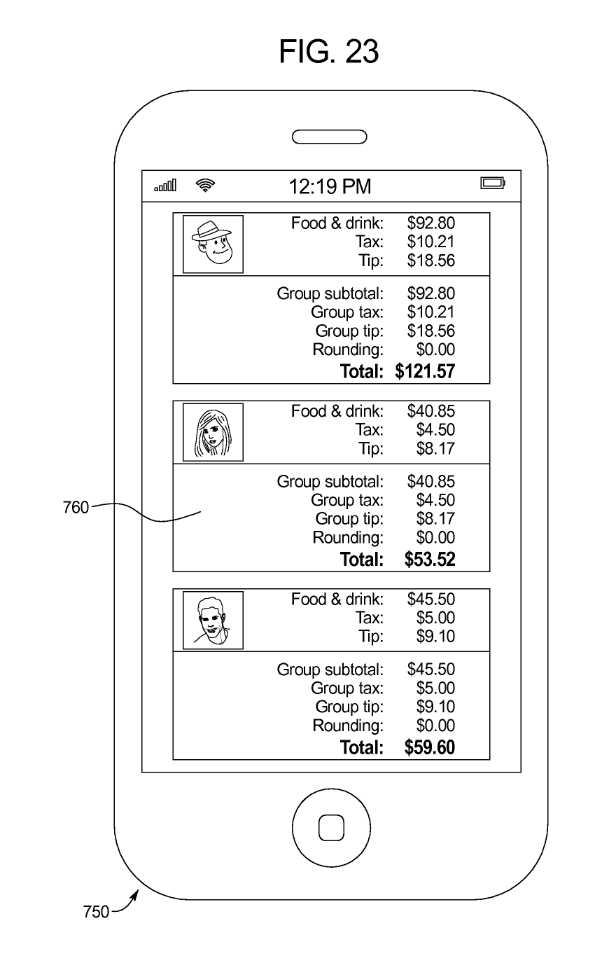

The assignment screen shows a status at the bottom indicating how many items are left to be assigned, helping the user in case one or more items can't immediately be seen without scrolling. The “Done” button on the bottom toolbar remains inactive until all items are assigned, preventing the user from reaching the payment screen 750 (FIG. 23) until all prices are accounted for.

Payment. When all price lines 650 have been assigned to a guest or split amongst a group of guests, the payment screen 750 is displayed as shown in FIG. 23. On the payment screen 750, guests can be dragged into parties that wish to pay together. Total 550, taxes 540, and tip information is computed and displayed for each party, and amounts such as the tip percentage can be configured.

The initial payment screen 750 displays a guest box 760 for each guest, plus a box at the bottom showing totals 550 for the entire meal. Each guest box 760 has the guest's icon 710 for identification, a drag icon on the opposite side, and then totals for each aspect of payment—the guest's subtotal 530 for food and drink items, their share of tax, their share of any discounts, their share of the tip, and then any adjustments to round the price to an even dollar amount, if the option has been selected at the bottom of the screen. The most important items—the guest's subtotal 530, tip amount, and total 550—may be highlighted in bold. The drag bar on the right-hand side of each guest's box can be use to combine guests into groups. Doing so causes each group's guest icons 710 to line up underneath each other, with each individual guest's subtotal and drag bar also appearing stacked up. The subsequent totals underneath reflect everyone in the group. By dragging an individual guest's drag bar away from the group's box, they can be split out and have their individual totals viewed once again.

A screen showing item total, taxes 540, subtotal, tip, discounts, rounding amount, and grand total 550 for the whole check may also be viewable. This is useful for things such as a tip calculator for the entire table, or as a final verification that the proper prices are being acted upon.

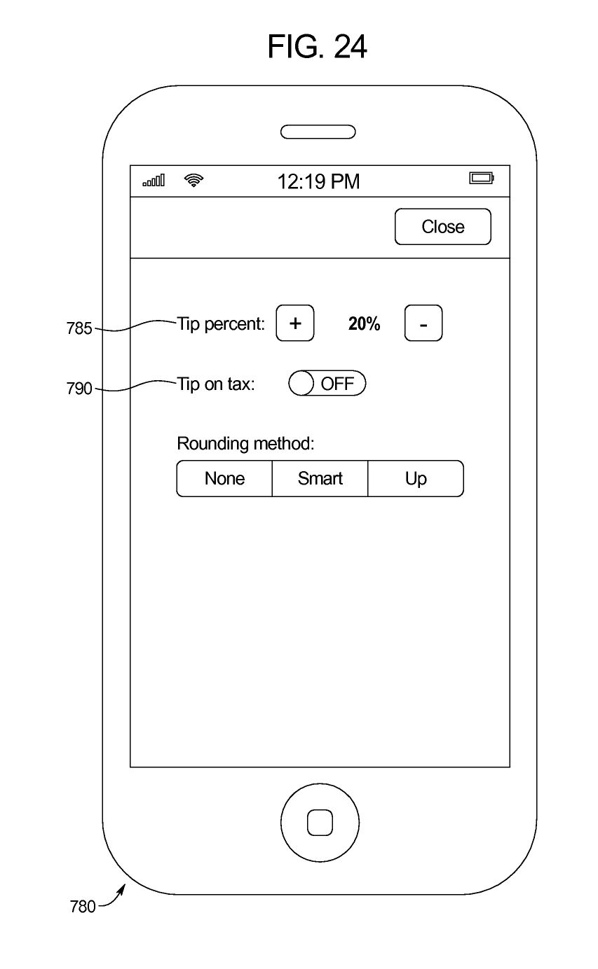

Details regarding the tip and rounding method can be adjusted. In FIG. 24, the status bar on the bottom contains a “Tip & Rounding” screen 780 to adjust certain aspects of payment calculation. Tapping it brings up a sheet allowing the changing of three settings—plus and minus buttons 785 allow adjusting the tip percentage, the user can toggle the “tip on tax” button 790 whether or not the tip calculations should include sales tax in the total, and different rounding methods can be enabled. “None” simply totals each guest's bill as it stands, “Up” rounds each guest's bill up to the nearest even dollar amount, and “Smart” will add or remove money from each guest's total, so that each guest ultimately owes an even dollar amount, and that amount is as close as possible to the actual total of the receipt without going under.

Bill payment. Once guests have been grouped into parties and total, tax, and tip have been calculated, each party then pays their share of the bill. Each party may choose to pay via cash or electronically. Electronic payment can be made using this application, using another function of this device, or using a different device.

In one embodiment, the application integrates with one or more payment service APIs in order to enable guests to pay directly from the pay screen. A payment method is chosen for each party, and the calculated total and tip amount are used to generate a payment request for each party's chosen API. Then, each party is given an opportunity to enter authentication credentials into the application, which are added to their payment request and sent to the payment API gateway. If authorized, payment is made immediately. This method may also be used with near-field communications to enable payment through a point of sale device.

In another embodiment, a payment request URL is constructed using the computed total and tip for each party, and used to launch a separate payment function on the user's device. Payment is then carried out using this external function for each party.

In another embodiment, the application constructs a payment request for each party, and sends it to one or more external devices operated by an individual from that party. Payment is then made using these external devices, and confirmation is sent back to the application.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A system comprising:
a processor;
a memory in communication with the processor, including stored instructions that, when executed by the processor, cause it to perform the steps of:
capturing an image of a document;
generating a model based on optical recognition of text data derived from the image, wherein the model includes:
a plurality of item elements, each item element including an item description and an item price; and
a total price or subtotal price, wherein the summation of the prices of the item elements equal the total price or subtotal price; and
providing a user interface to permit a user to assign one or more item elements to one of a plurality of groups wherein the assigned item elements are used to calculate an assigned cost for each of the groups.

2. The system of claim 1, wherein the step of generating a model based on optical recognition of text data derived from the image includes the steps of:
analyzing the image to determine a plurality of line segments;
analyzing each line segment to determine one or more character segments;
analyzing each character segment to determine a plurality of possible interpretations, each interpretation having an associated predicted probability of being an accurate representation of the character in the document; and
forming one or more document models based on combinations of the possible interpretations of the character segments.

3. The system of claim 2, wherein the character segment interpretations and document models are represented by weighted finite state transducers.

4. The system of claim 3, wherein the memory further includes stored instructions that when executed by the processor cause it to perform the step of: providing a user interface through which a user verifies the accuracy of one of an item price, a subtotal price, or a total price.

5. The system of claim 4, wherein the user verification eliminates one or more models from being selected as the document model having the highest predicted likelihood of the summation of the price associated with each of the item elements equaling the total or subtotal.

6. The system of claim 1, wherein the user interface permits a user to assign one or more item elements to one of a plurality of groups includes a graphical representation of the item elements and a graphical representation of the plurality of groups wherein the user may manipulate graphical representation of an item element to assign the item element to the group.

7. The system of claim 6, wherein the user manipulates the graphical representation of an item element to assign the item element to the group through a touch screen based interface.

8. The system of claim 1, wherein the plurality of item elements represent items collectively purchased by individuals and each group of the plurality of groups includes one or more of the individuals.

9. The system of claim 8, wherein the memory further includes stored instructions that when executed by the processor cause it to perform the step of: initiating an electronic payment API request to send or receive payment for at least one of the one or more guests.

10. The system of claim 1, wherein the step of providing a user interface to permit a user to assign one or more item elements to one of a plurality of groups includes displaying a zoomed-in image of the document generated by the steps of:
identifying foreground pixels and background pixels in the image of the document;
extracting the foreground pixels;
filling in the foreground pixels using background estimation to form a background image of the document;
modifying the foreground pixels to eliminate whitespace; and
rendering the foreground pixels onto the background image of the document to generate a modified electronic version of the document with reduced whitespace.

11. The system of claim 10, wherein the step of displaying a zoomed-in image of the document includes the step of: rendering sharper text over the foreground pixels by replacing the foreground pixels with the item descriptions and item prices from the model having the highest predicted likelihood of the summation of the price associated with each of the item elements equaling the total or subtotal.

12. An optical character recognition system comprising:
a processor;
a memory in communication with the processor, including stored instructions that, when executed by the processor, cause it to perform the steps of:
capturing an image of a document, wherein the captured image includes a set of numbers having a defined mathematical relationship;
generating a plurality of document models each including a unique set of numbers based on a unique interpretation of the captured image;
searching the plurality of document models to select a document model satisfying the defined mathematical relationship and having the highest predicted probability of being an accurate representation of the document; and
outputting the optical character recognition version of the captured image based on the selected model.

13. The system of claim 12, wherein the step of generating a plurality of document models each including a unique set of numbers based on a unique interpretation of the captured image includes the steps of:
identifying a plurality of line segments in the captured image;
identifying one or more character segments in each line segment;
generating a plurality of line segment models by assigning one or more values to each character segment in each line segment, wherein each assigned value includes an associated predicted likelihood of being an accurate representation of the character in the document; and
generating a plurality of document models from combinations of line segment models.

14. The system of claim 13, wherein the line segment models and document models are represented by weighted finite state transducers.

15. The system of claim 14, wherein the memory further includes stored instructions that, when executed by the processor, cause it to perform the step of: providing a user interface through which a user verifies the accuracy of one of the line segment models.

16. The system of claim 15, wherein the document is a receipt including a plurality of item elements, each item element including an item description and an item price, and a total price or subtotal price, wherein the defined mathematical relationship is that the summation of the prices of the item elements equal the total price or subtotal price.

17. The system of claim 16, wherein the memory further includes stored instructions that when executed by the processor cause it to perform the step of: providing a user interface to permit a user to assign one or more item elements to one of a plurality of groups wherein the assigned item elements are used to calculate an assigned cost for each of the groups.

18. The system of claim 19, wherein the step of providing a user interface to permit a user to assign one or more item elements to one of a plurality of groups includes displaying a zoomed-in image of the document generated by the steps of:
identifying foreground pixels and background pixels in the image of the document;
extracting the foreground pixels;
filling in the foreground pixels using background estimation to form a background image of the document;
modifying the foreground pixels to eliminate whitespace; and
rendering the foreground pixels onto the background image of the document to generate a modified electronic version of the document with reduced whitespace.

19. The system of claim 18, wherein the user interface permits a user to assign one or more item elements to one of a plurality of groups includes a graphical representation of the item elements and a graphical representation of the plurality of groups wherein the user may manipulate graphical representation of an item element to assign the item element to the group.

20. An optical character recognition system comprising:
a processor;
a memory in communication with the processor, including stored instructions that, when executed by the processor, cause it to perform the steps of:
capturing an image of a document, wherein the captured image includes a set of numbers having a defined mathematical relationship;
analyzing the image to determine a plurality of line segments;
analyzing each line segment to determine one or more character segments;
analyzing each character segment to determine a plurality of possible interpretations, each interpretation having an associated predicted likelihood of being an accurate representation of the character in the document;
forming a weighted finite state transducer for each interpretation, wherein the weights are based on the predicted probabilities;
combining the weighted finite state transducer for each interpretation into a document model weighted finite state transducer that encodes the defined mathematical relationship;
searching the document model weighted finite state transducer for the lowest weight path, which is an interpretation of the document that is most likely to accurately represent the document; and
outputting an optical character recognition version of the captured image based on the lowest weight path of the document model weighted finite state transducer.
